(19) United States
(12) Patent Application Publication
(10) Pub. No.: US 2026/0257875 A1
(43) Pub. Date: Sep. 3, 2026

(54) AUTOMATED LOADING AND UNLOADING APPARATUS AND TRANSPORT SYSTEM

(71) Applicant: Dimension Product Solutions LP, Crosby, TX (US)

(72) Inventors: George T. Cook, Crosby, TX (US); Burt Lusk, La Porte, TX (US)

(21) Appl. No.: 19/655,563

(22) Filed: Apr. 22, 2026

Related U.S. Application Data
(63) Continuation-in-part of application No. 18/740,460, filed on Jun. 11, 2024, now Pat. No. 12,703,413.

(51) Int. Cl. B65G 67/02; B61B 13/12; B65G 69/00

(52) U.S. Cl. CPC B65G 67/02; B61B 13/12; B65G 69/006

(57) ABSTRACT

A transport system for a loading and unloading apparatus used at a facility, where the transport system includes a transport apparatus configured to receive the loading and unloading apparatus. The transport apparatus includes a frame having a bottom wall and opposing sidewalls extending from the bottom wall, and at least one drive assembly attached to the frame. A plurality of tracks are fixed in a floor of the facility, where the at least one drive assembly is positioned in one of the plurality of tracks. The drive assembly moves the transport apparatus along the plurality of tracks to different positions on the floor of the facility.

### CROSS REFERENCE TO RELATED APPLICATIONS

This application is a continuation-in-part application of and claims priority to U.S. Patent Application No. 18/740,460 filed on June 11, 2024, which is incorporated herein by reference.

### BACKGROUND

The present application relates generally to an apparatus for loading materials in and unloading materials from containers, and more particularly, to an apparatus for simultaneously loading large quantities of products and unloading large quantities of products as a consolidated unit to and from containers, such as storage containers or shipping containers, or moving the consolidated unit to different locations in a processing plant, and a transport system for transporting the apparatus to different loading and unloading areas in a facility. The apparatus and transport system enables products to be loaded and unloaded to and from containers in significantly less time than conventional loading and unloading apparatuses to reduce processing and shipping costs.

Containers are used to store and transport different types of products. These containers are commonly attached to or supported by transport vehicles, such as trucks or railcars, and transported to a designated location. In conventional shipping systems, the products are placed on a support structure such as a pallet, and then moved by a forklift, lift truck or similar apparatus, which are configured to lift and move the pallet with the products to a designated location or into a container or out of a container. Typically, each pallet is moved separately into and out of the containers, which is time consuming, requires skilled operators and increases the likelihood of damage to the products.

Some loading and unloading systems can load products and materials into containers as a complete load. However, these systems do not interface with conventional pallets and either convey or slide products or materials into a container by pushing the products. It is difficult to move and align the products with the containers using this process and it’s also very difficult to unload the products from containers.

Therefore, it is desirable to provide a loading and unloading apparatus that moves large quantities of products and a transport system for transporting the apparatus that is efficient while reducing processing and shipping time and costs.

### SUMMARY

The present transport system is configured to move a container loading and unloading apparatus carrying a consolidated unit comprising several support structures, such as pallets, holding products, between locations at a processing or manufacturing facility. The loading and unloading apparatus simultaneously moves several pallets of products as a consolidated unit to and from containers or transporting the consolidated unit to different locations at a processing or manufacturing facility, which reduces transport time and saves significant time and money. The transport system moves the loading and unloading apparatus laterally along a floor of the facility to different door openings at the facility to load and unload the consolidated unit to and from trailers positioned at the door openings at the facility.

In an embodiment, a loading and unloading apparatus is provided and includes a transport assembly and a lift assembly including a plurality of support members, where each of the support members is attached to the transport assembly and includes an actuator plate. A plurality of roller assemblies are movably attached to the support members and the actuator plates, where the roller assemblies move relative to the support members to move the lift assembly between a raised position and a lowered position, and where a drive vehicle engages the transport assembly to move the support members of the lift assembly through through-holes of a plurality of support structures holding products configured as a consolidated unit, until the transport assembly engages a first support structure of the consolidated unit. The roller assemblies move in different directions to raise and lower the lift assembly carrying the consolidated unit.

In another embodiment, a loading and unloading apparatus is provided and includes a transport assembly and a lift assembly including support members each having a plurality of interconnected intermediate members and a drive member connected to one of the intermediate members, each of the intermediate members includes a housing and an intermediate actuator plate that moves relative to the housing, and the drive member includes a drive actuator plate, where the intermediate actuator plates and the drive actuator plate are coupled together to form an actuator plate in each of the support members, a plurality of roller assemblies are movably attached to the support members, where the plurality of roller assemblies move the lift assembly between a raised position and a lowered position, where when the lift assembly is in the lowered position, a drive vehicle engages the transport assembly to move the support members of the lift assembly through through-holes of a plurality of support structures holding products configured as a consolidated unit, until the transport assembly engages a first support structure of the consolidated unit, and where the roller assemblies move the lift assembly to the raised position to raise the consolidated unit away from an underlying surface and enable the drive vehicle to move the consolidated unit to another location or into or out of a container, and the roller assemblies move the lift assembly to the lowered position to lower the consolidated unit to the underlying surface to enable the drive vehicle to move the lift assembly away from the consolidated unit and remove the consolidated unit from the lift assembly.

In an embodiment, a transport system is provided for the loading and unloading apparatus used at a facility, where the transport system includes a transport apparatus configured to receive the loading and unloading apparatus. The transport apparatus includes a frame having a bottom wall and opposing sidewalls extending from the bottom wall, and at least one drive assembly attached to the frame. A plurality of tracks are fixed in a floor of the facility, where the at least one drive assembly is positioned in one of the plurality of tracks. The drive assembly moves the transport apparatus along the plurality of tracks to different positions on the floor of the facility.

In another embodiment, a transport system is provided for the loading and unloading apparatus used at a facility, where the transport system includes a container alignment apparatus secured adjacent to a door opening at the facility, where the container alignment apparatus including opposing guide walls configured to guide wheels of a trailer so that a door opening of the trailer is aligned with the door opening at the facility. The transport system includes a transport apparatus configured to receive the loading and unloading apparatus, where the transport apparatus includes a frame having a bottom wall and opposing sidewalls extending from the bottom wall, and at least one drive assembly attached to the frame. A plurality of tracks are fixed in a floor of the facility, where the at least one drive assembly is positioned in one of the plurality of tracks. The drive assembly moves the transport apparatus along the plurality of tracks to align the transport apparatus with the door opening at the facility.

### BRIEF DESCRIPTION OF THE DRAWINGS

FIG. 1 is a perspective view of the present loading and unloading apparatus.

FIG. 2A is a top view of the loading and unloading apparatus of FIG. 1.

FIG. 2B is a side view of the loading and unloading apparatus of FIG. 1.

FIG. 2C is a bottom view of the loading and unloading apparatus of FIG. 1.

FIG. 2D is a perspective view of two of the support members of the loading and unloading apparatus of FIG. 1.

FIG. 3A is a fragmentary side view of the loading and unloading apparatus of FIG. 1.

FIG. 3B is a rear perspective view of the transport assembly of the loading and unloading apparatus of FIG. 1.

FIG. 3C is a front perspective view of the transport assembly of the loading and unloading apparatus of FIG. 1.

FIG. 3D is a top view of the transport assembly of the loading and unloading apparatus of FIG. 1.

FIG. 3E is a front view of the transport assembly of the loading and unloading apparatus of FIG. 1.

FIG. 3F is a right side view of the transport assembly of the loading and unloading apparatus of FIG. 1, where the left side view is a mirror image of this view.

FIG. 3G is a rear view of the transport assembly of the loading and unloading apparatus of FIG. 1.

FIG. 4 is a side view of the drive member of the lift assembly shown in FIG. 1.

FIG. 5 is a side view of the lift assembly showing the lift assembly of FIG. 1 in the lowered position.

FIG. 6 a fragmentary side view of the lift assembly showing the lift assembly in the raised position.

FIG. 7A is a side view of an intermediate member showing the housing and the actuator plate.

FIG. 7B is a perspective view of the intermediate member of FIG. 7A.

FIG. 7C is a perspective view of an intermediate actuator plate of the intermediate member of FIG. 7A.

FIG. 7D is a top view of the intermediate member of FIG. 7A.

FIG. 7E is a side view of the intermediate member of FIG. 7A.

FIG. 7F is a bottom view of the intermediate member of FIG. 7A.

FIG. 7G is a top view of the intermediate actuator plate of FIG. 7C.

FIG. 7H is a side view of the intermediate actuator plate of FIG. 7C.

FIG. 7I is a bottom view of the intermediate actuator plate of FIG. 7C.

FIG. 8 is a side view of intermediate members of the lift assembly that are connected together.

FIG. 9 is a fragmentary perspective view of an end member of the loading and unloading apparatus of FIG. 1.

FIG. 10 is a side view of the lift assembly engaged with a pallet where the lift assembly is in the lowered position.

FIG. 11 is a side view of the lift assembly engaged with a pallet where the lift assembly is in the raised position.

FIG. 12 is a side view of the loading and unloading apparatus of FIG. 1.

FIG. 13 is a side view of the loading and unloading apparatus of FIG. 1 showing a forklift engaged with the loading and unloading apparatus.

FIG. 14 is a side view of the loading and unloading apparatus of FIG. 13 being moved by the forklift toward a consolidated unit including several pallets holding products.

FIG. 15 is a side view of the loading and unloading apparatus of FIG. 13 showing the forklift fully engaged with the consolidated unit including several pallets holding products.

FIG. 16 is a side view of the loading and unloading apparatus of FIG. 13 where the forklift has lifted the loading and unloading apparatus to move the pallets into a container.

FIG. 17 is a side view of the loading and unloading apparatus where the forklift has lowered the loading and unloading apparatus to lower the consolidated unit to the lowered position.

FIG. 18 is a side view of the loading and unloading apparatus where the forklift has removed the loading and unloading apparatus from the consolidated unit.

FIG. 19 is a fragmentary perspective view of a transport system for the loading and unloading apparatus showing a view from outside of a facility.

FIG. 20 is a fragmentary perspective view of the transport system for the loading and unloading apparatus showing a view from inside of the facility.

FIG. 21 is a fragmentary perspective view of outside of the facility showing a shipping container at a docking station.

FIG. 22 is a front perspective view of an embodiment of a guide assembly at a docking station shown in FIG. 21.

FIG. 23 is a rear perspective view of the guide assembly of FIG. 22.

FIG. 24 is a fragmentary perspective view of an embodiment of the transport system for the loading and unloading apparatus.

FIG. 25 is a front perspective view of a transport apparatus of the transport system of FIG. 24.

FIG. 26A is a rear perspective view of the transport apparatus of FIG. 25.

FIG. 26B is an exploded perspective view of the first drive assembly.

FIG. 26C is a fragmentary perspective view of the drive assembly and the chain assembly of the first drive assembly shown in FIG. 26B.

FIG. 27 is a storage area for the loading and unloading apparatus.

FIG. 28 is a perspective view of railings and guide rails in the storage area of FIG. 27.

FIG. 29 is a front perspective view of the transport apparatus of FIG. 25 with the loading and unloading apparatus moved fully within the transport apparatus.

FIG. 30 is a rear perspective view of the transport apparatus of FIG. 29.

FIG. 31 is a side view of the transport apparatus of FIG. 29.

### DETAILED DESCRIPTION

The present container loading and unloading apparatus is configured for loading and unloading large quantities of products on several support structures, such as pallets, as a consolidated unit to and from containers, such as storage containers or shipping containers, dry vans or trucks and trailers or between locations at a processing facility or manufacturing facility. Simultaneously moving several pallets of products as a consolidated unit to and from containers or transporting the consolidated unit to different locations at a processing or manufacturing facility, saves significant time and money.

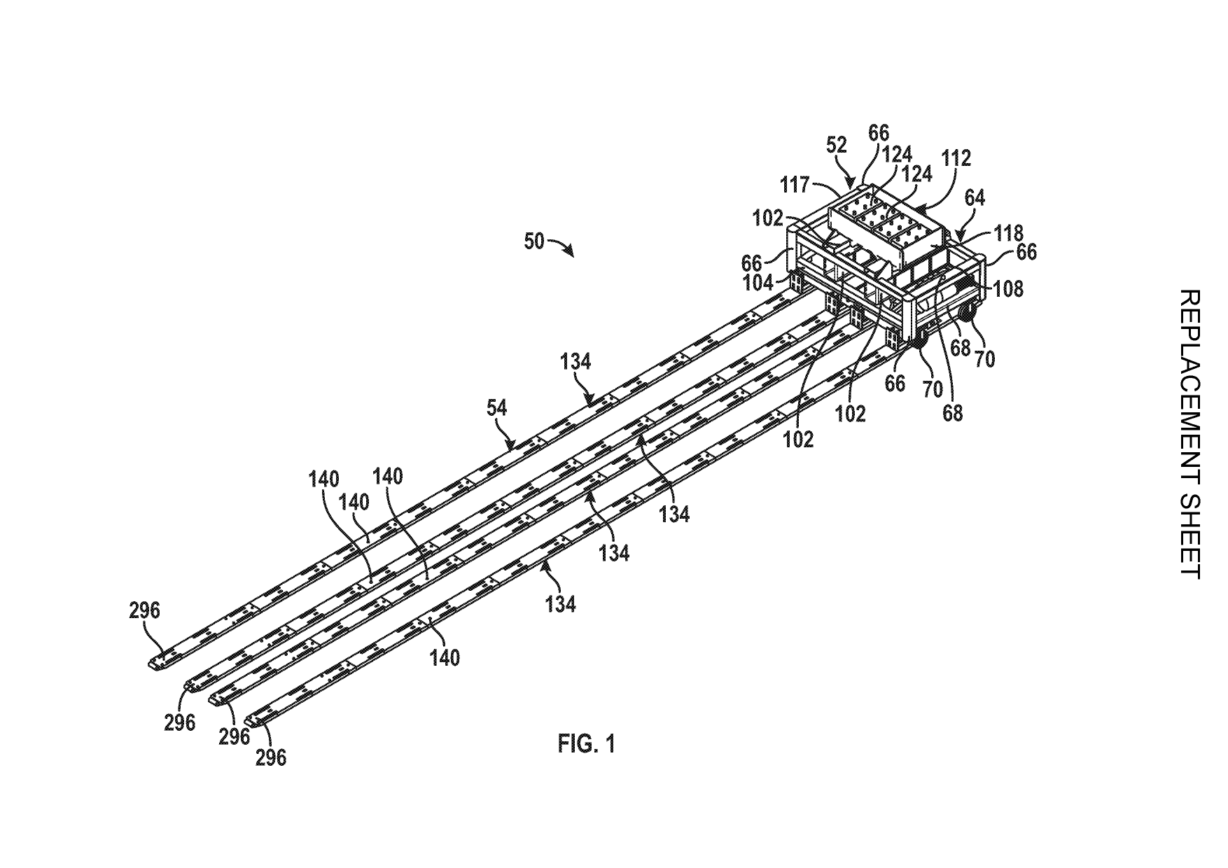

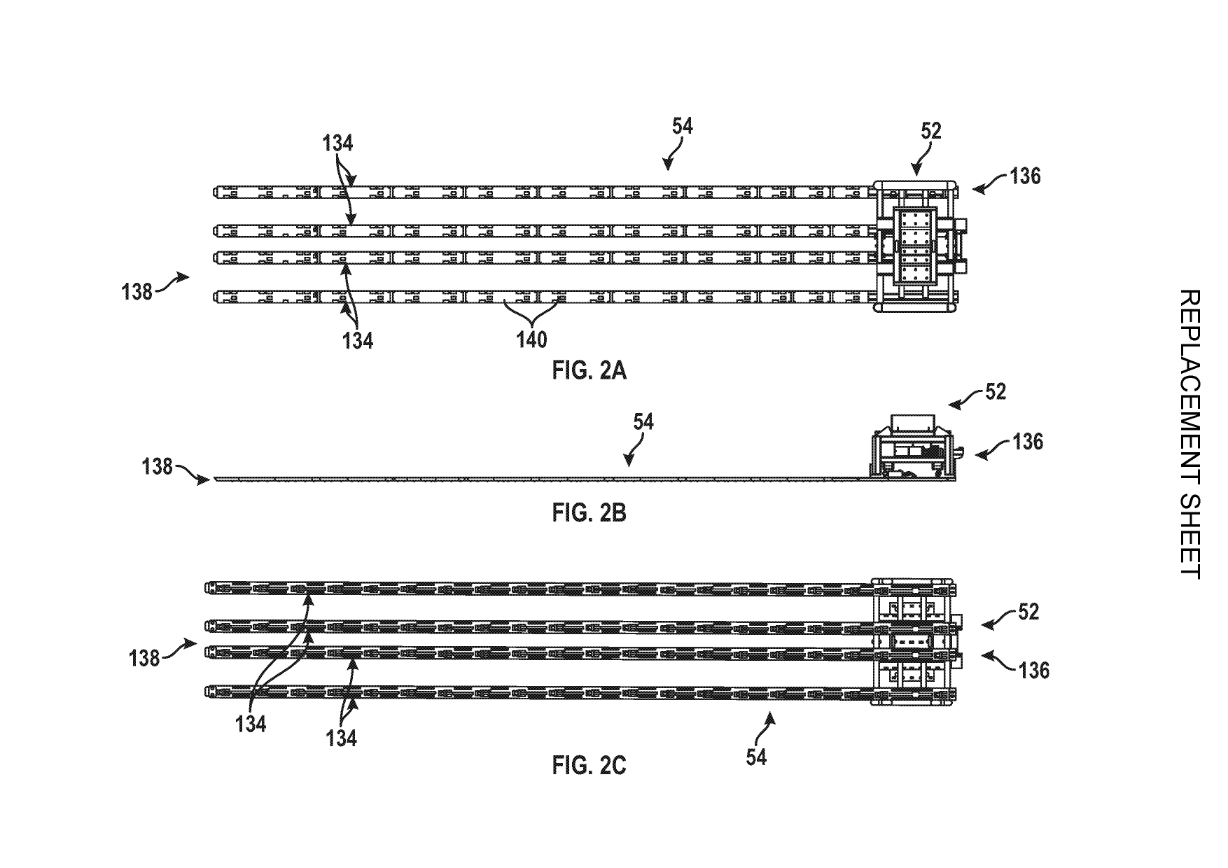

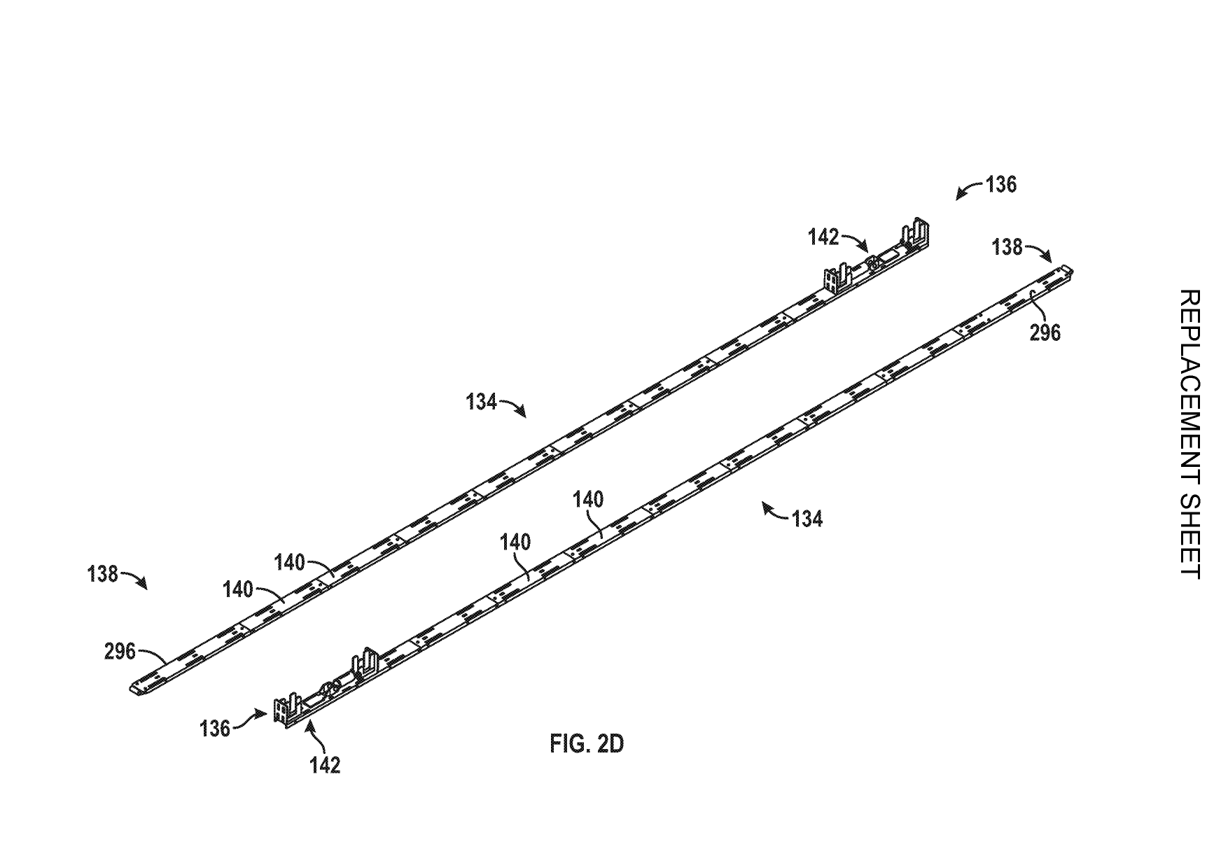

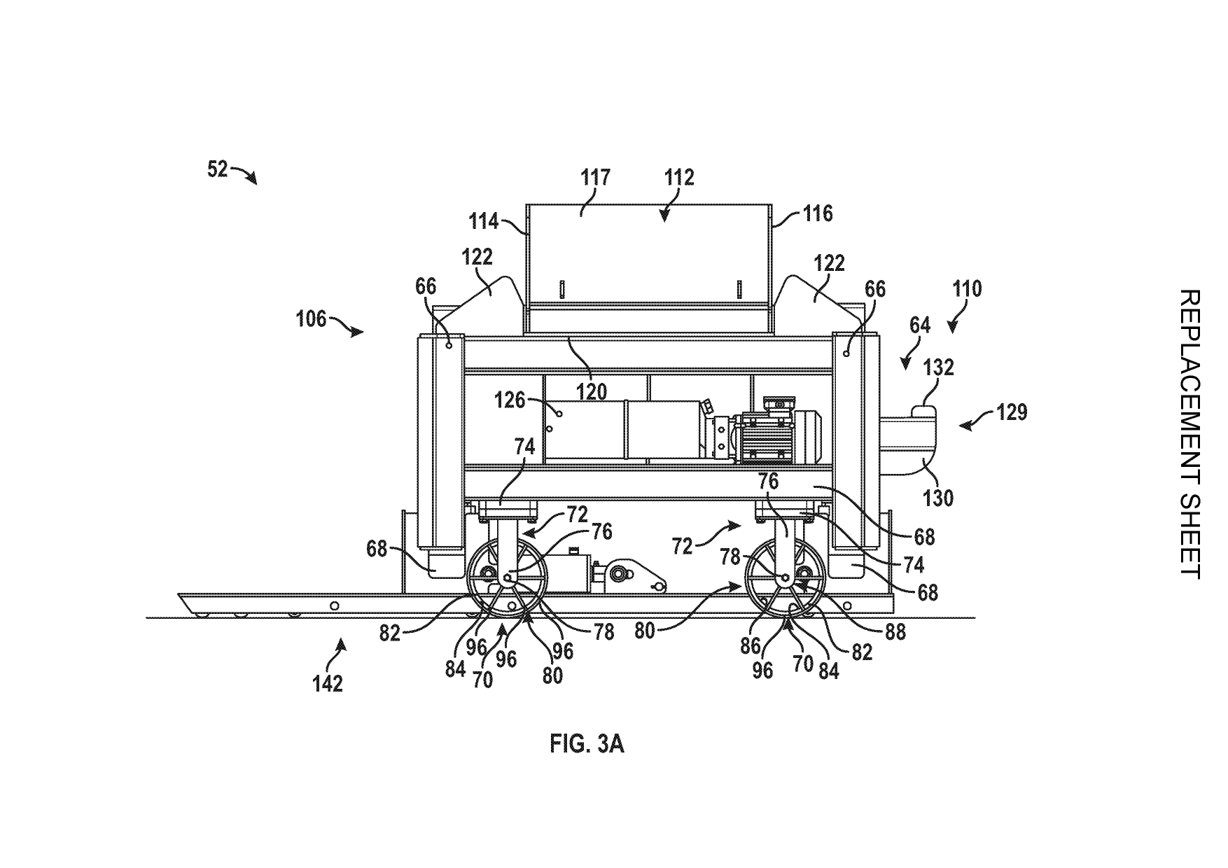

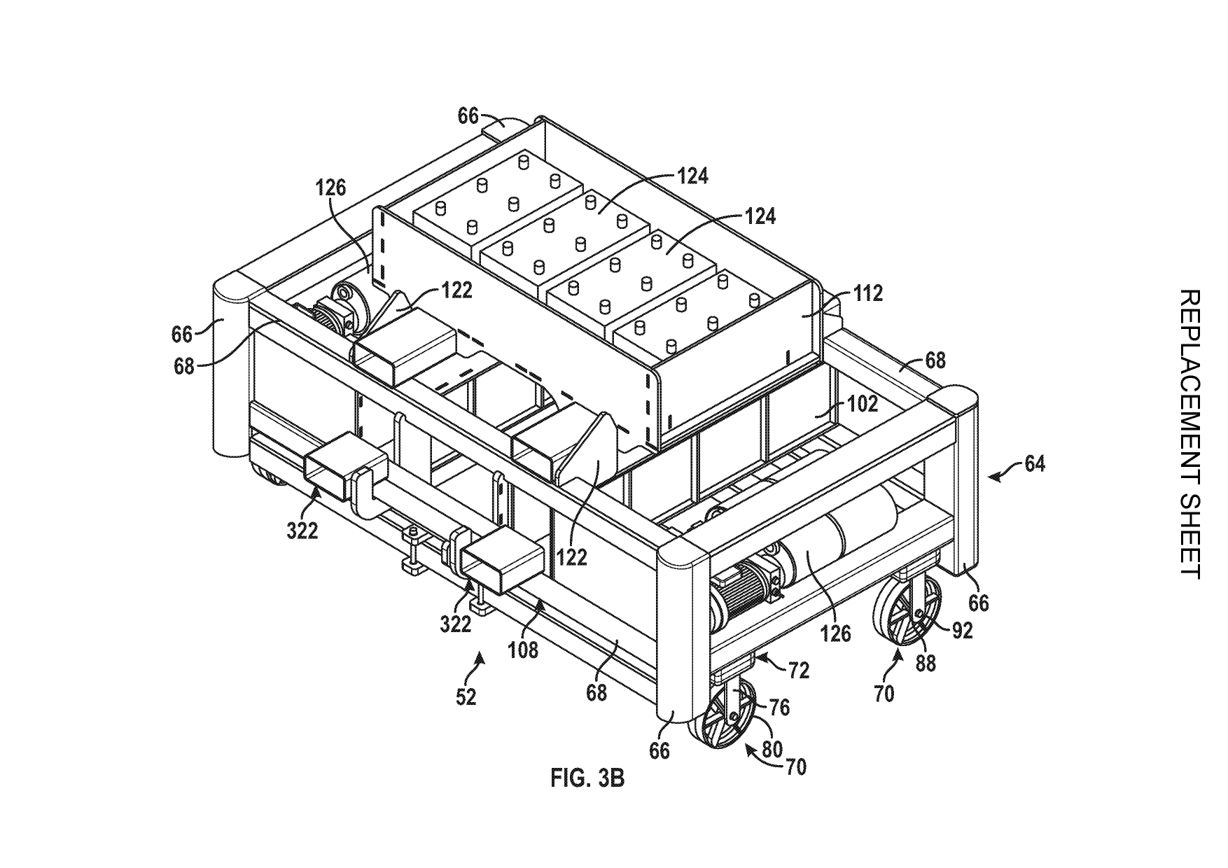

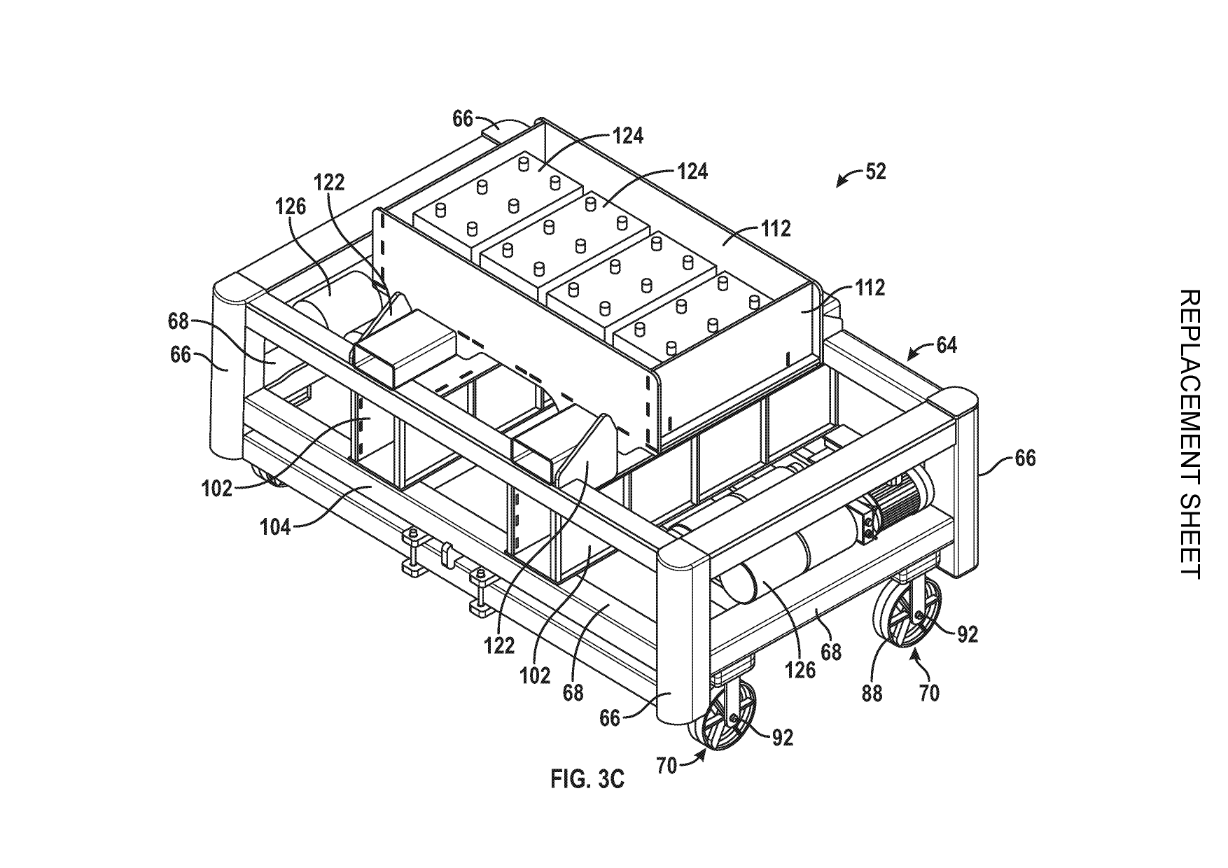

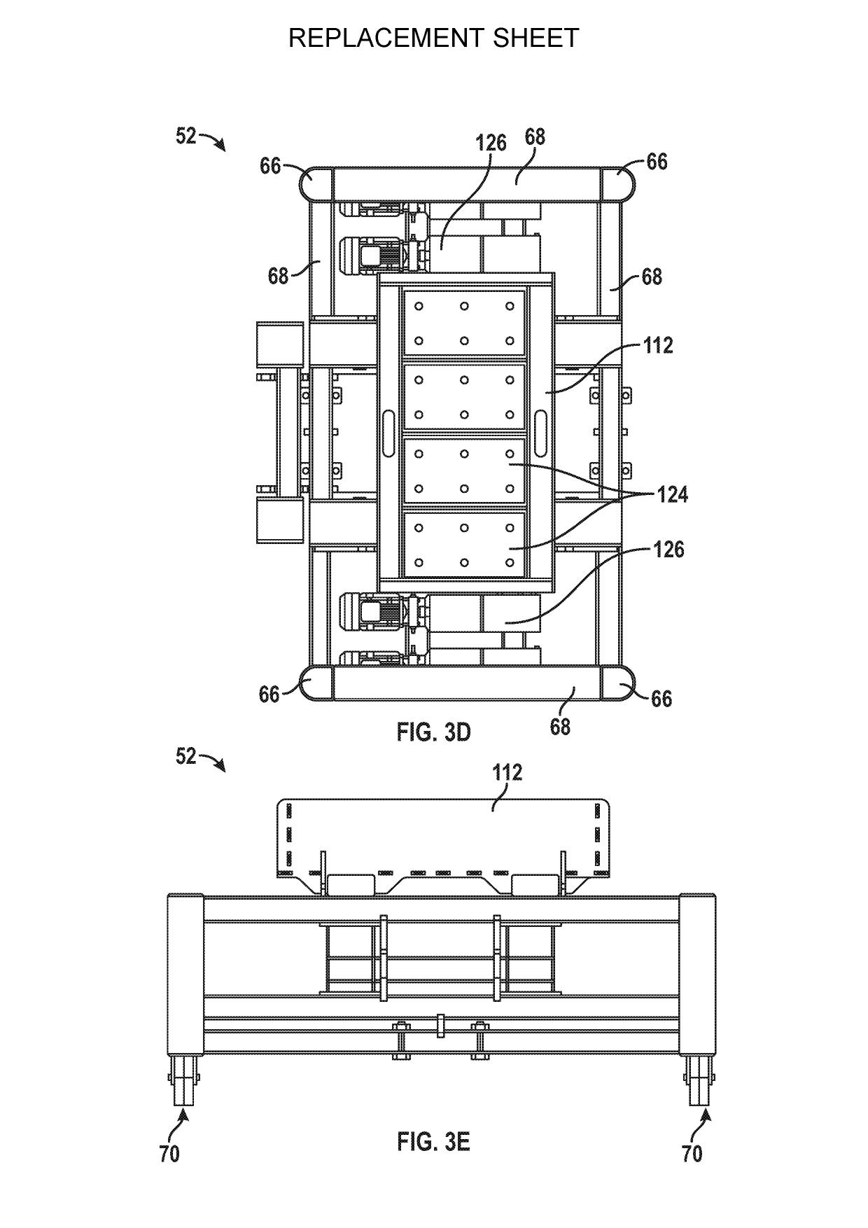

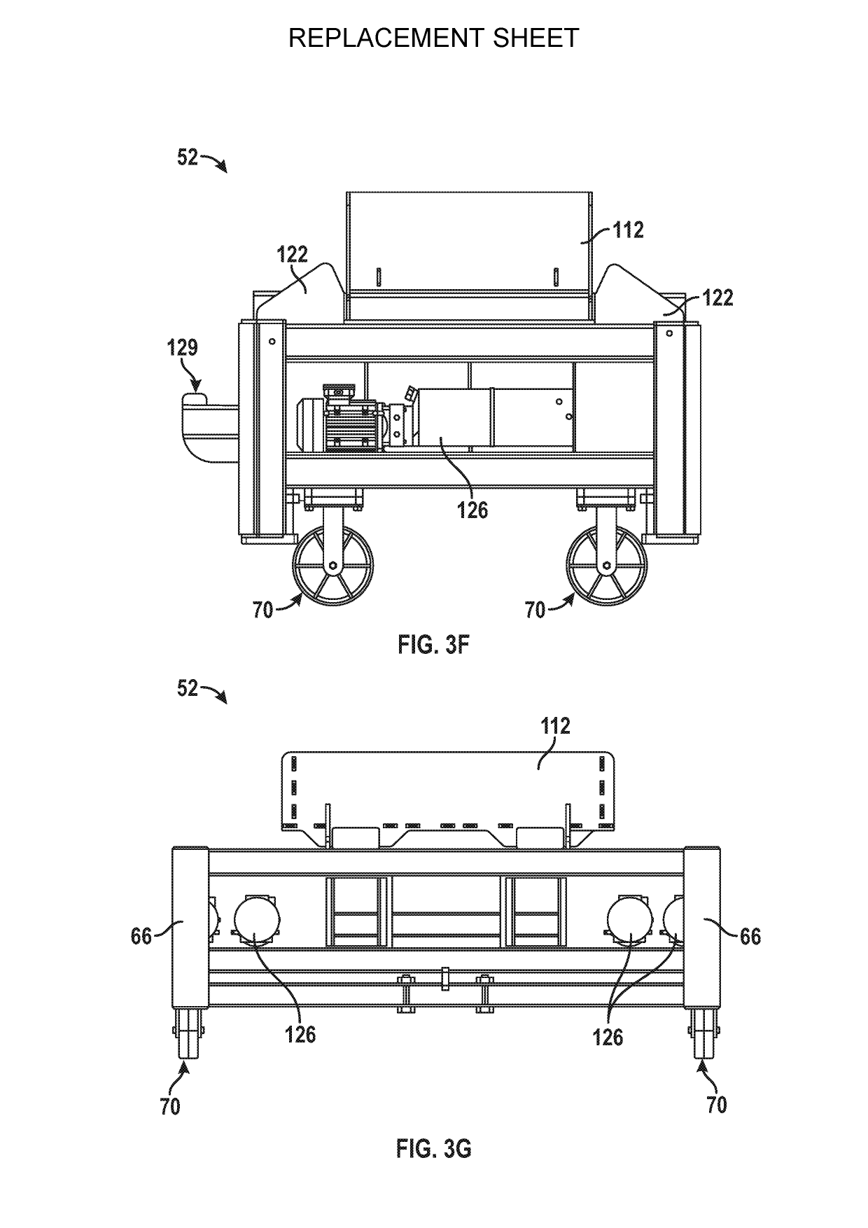

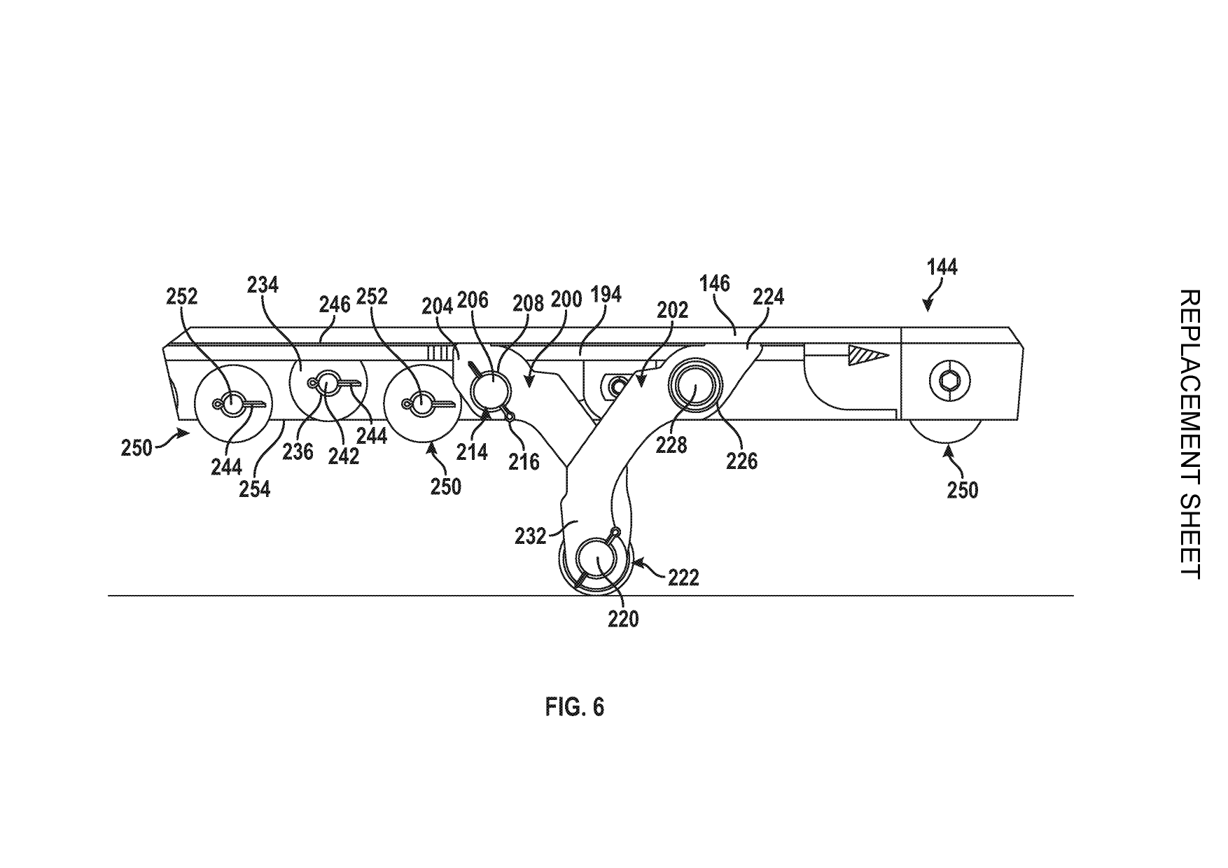

Referring now to FIGS. 1-11, the present container loading and unloading apparatus 50 includes a transport assembly 52 connected to a lift assembly 54 where the lift assembly 54 engages multiple support structures, such as pallets 56, each holding products 58, as a consolidated unit 60 and moves the consolidated unit. A vehicle, such as a forklift 62, engages the transport assembly 52, which is connected to the lift assembly 54, and moves the consolidated unit 60, between locations or into and out of a container associated with a van, a truck, a trailer or similar transport vehicle.

The transport assembly 52 includes a main frame 64 formed by interconnected vertical support members 66 and horizontal support members 68 that are connected together by welding, rivets or by suitable fasteners. Two wheel assemblies 70 are connected to opposing sides of the main frame 64 and are configured to enable the transport assembly 52 to move along an underlying surface, such as the floor of a processing plant, the floor of a container or the ground. As shown, the wheel assemblies 70 include a wheel bracket 72 that each have a base mount 74 and opposing legs 76 extending from the base mount 74. The legs 76 extending from each base mount 74 are spaced from each other and have a through-hole 78, where the through-holes of the legs 76 are aligned with each other. A wheel 80 is connected to the legs 76, where each wheel includes a rim 82 with a rim base 84 and a plurality of spokes 86. Specifically, the spokes 86 extend between the rim base 84 and a hub 88 and provide support for the wheels. The hub 88 includes a through-hole that is aligned with the through-holes 78 of the legs 76, where a fastener is inserted through the through-holes 78 and secured in position by a washer and nut 92. A tire 96, made of rubber or other suitable material or combination of materials, is mounted to the outer surface of the rim 82 and provides traction on an underlying surface.

In an embodiment, the tire 96 includes a plurality of tread members (not shown) that extend from the surface of the tire and help the tire grip the underlying surface. The tire 96 also has an air valve (not shown) that enables the tire to receive air to fill the interior of the tire to a predetermined air pressure. In another embodiment, the tire 96 is made with a durable material that does not require air, and provides sufficient traction with the underlying surface.

In the illustrated embodiment, two wheel assemblies 70 are mounted on opposing sides of the main frame 64. In another embodiment, two or more of the wheel assemblies 70 are mounted to the opposing sides of the main frame 64 and between the opposing sides of the main frame 64. For example, four of the wheel assemblies 70 may be mounted to the main frame 64 between opposing sides of the main frame such that there are eight wheel assemblies mounted to the main frame. It should be appreciated that any suitable number of the wheel assemblies 70 may be mounted to the main frame 64 to help the transport assembly 52 move along an underlying surface.

Referring to FIGS. 1 to 4, two battery mounting members 102 are mounted to the main frame 64 between the opposing sides of the main frame. The battery mounting members 102 are rectangular mounting members that include four walls that are welded together or connected together by rivets or fasteners. In the illustrated embodiment, the battery mounting members 102 are positioned on and mounted to the front frame member 104 at a first end 106 and a rear frame member 108 at a second end 110. A battery housing 112 formed by a front wall 114, a rear wall 116, opposing sidewalls 117 and 118, and a bottom wall 120 that are connected together by welding or fasteners. The battery housing 112 is guided into position by frame guides 122 on the battery mounting members 102 and seated on an upper surface of the battery mounting members. As shown in FIG. 1, a plurality of battery packs 124 are positioned in the battery housing 112. It should be appreciated that there may be one battery pack 124 or a plurality of battery packs 124 in the battery housing 112. The battery packs 124 are electrically connected to each other and provide power to the hydraulic power units 126.

In an embodiment, the main frame 64 includes a transport connector 129 that extends from the main frame. The transport connector 129 includes a base 130 and a stop member 132 extending transversely from the base, where the stop member 132 engages a portion of the frame of a vehicle, such as the forklift 62, so that the transport assembly 52 remains connected to the forklift 62 during loading and unloading processes. The transport assembly 52 may be disconnected from the forklift 62 by raising the forklift

lifting mechanism 134 (FIG. 13) and then moving the forklift 62 away from the transport assembly 52.

The lift assembly 54 includes a plurality of forks or support members 134, where each of the support members 134 includes a first end or rear end 136 and an opposing second end or front end 138. In the illustrated embodiment, each support member 134 includes a plurality of interconnected intermediate members 140. The number of intermediate members 140 that are connected together to form the support members 134 depends on the number of support structures (pallets 56) being moved by the unloading and loading apparatus 50, i.e., the overall length of the consolidated unit 60 including the pallets 56.

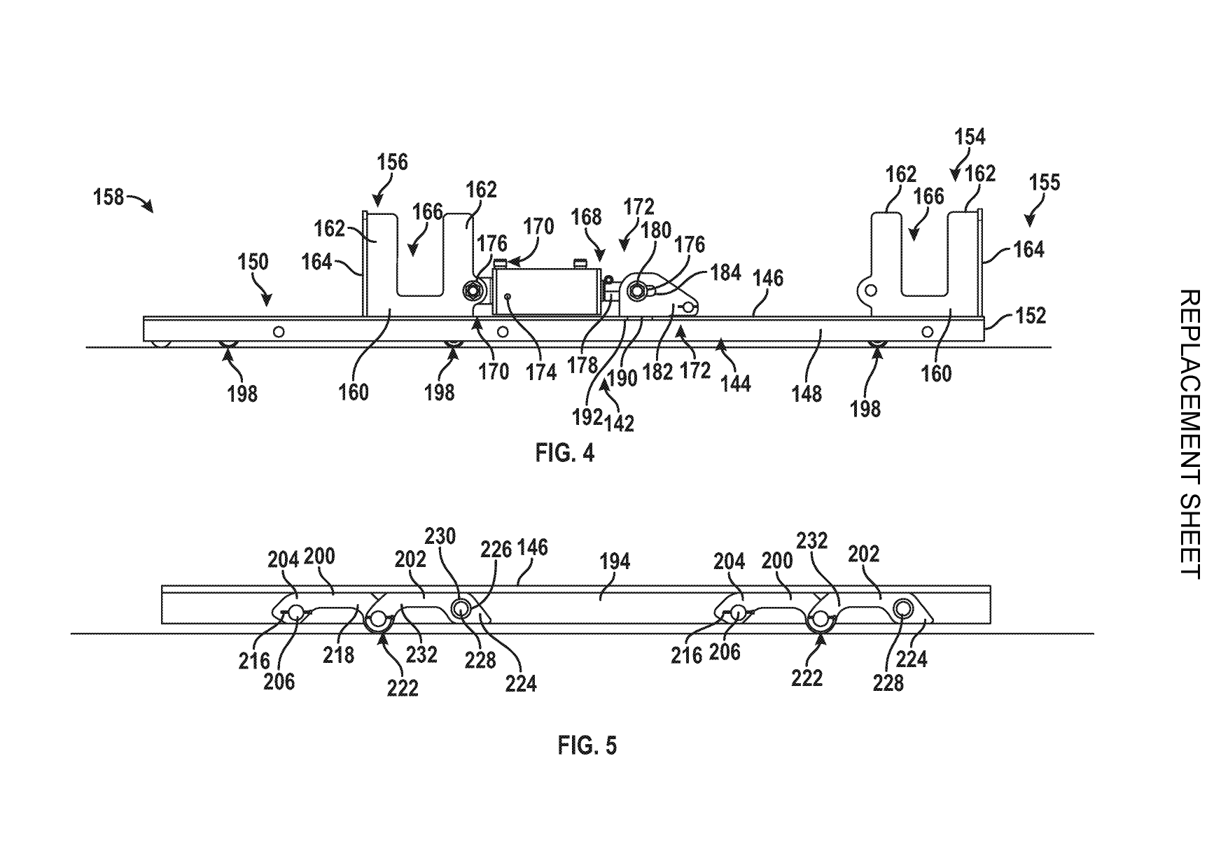

Referring to FIGS. 1 to 4, at the rear ends 136 of each of the support members 134 is a drive member 142, which enables the support members 134 to be raised, lowered and moved by the transport assembly 52. In the illustrated embodiment, the drive member 142 includes a housing 144 having a top wall 146, opposing sidewalls 148 and 150, and an end wall 152. A pair of first support brackets 154 are mounted at the rear end 155 of the housing 144 and a pair of second support brackets 156 are mounted between the front end 158 and the rear end 155 of the housing 144. As shown in FIG. 4, the first support brackets 154 and the second support brackets 156 are laterally spaced from each other, and preferably are adjacent to each of the sidewalls 148, 150 of the housing 144. It should be appreciated that the drive member 142 may have any suitable number of support brackets that are positioned at any location on the housing 144. In this embodiment, each of the first and second support brackets 154, 156 includes

a base wall 160 and opposing, vertically extending walls 162 that are integrally formed together and have a u-shape.

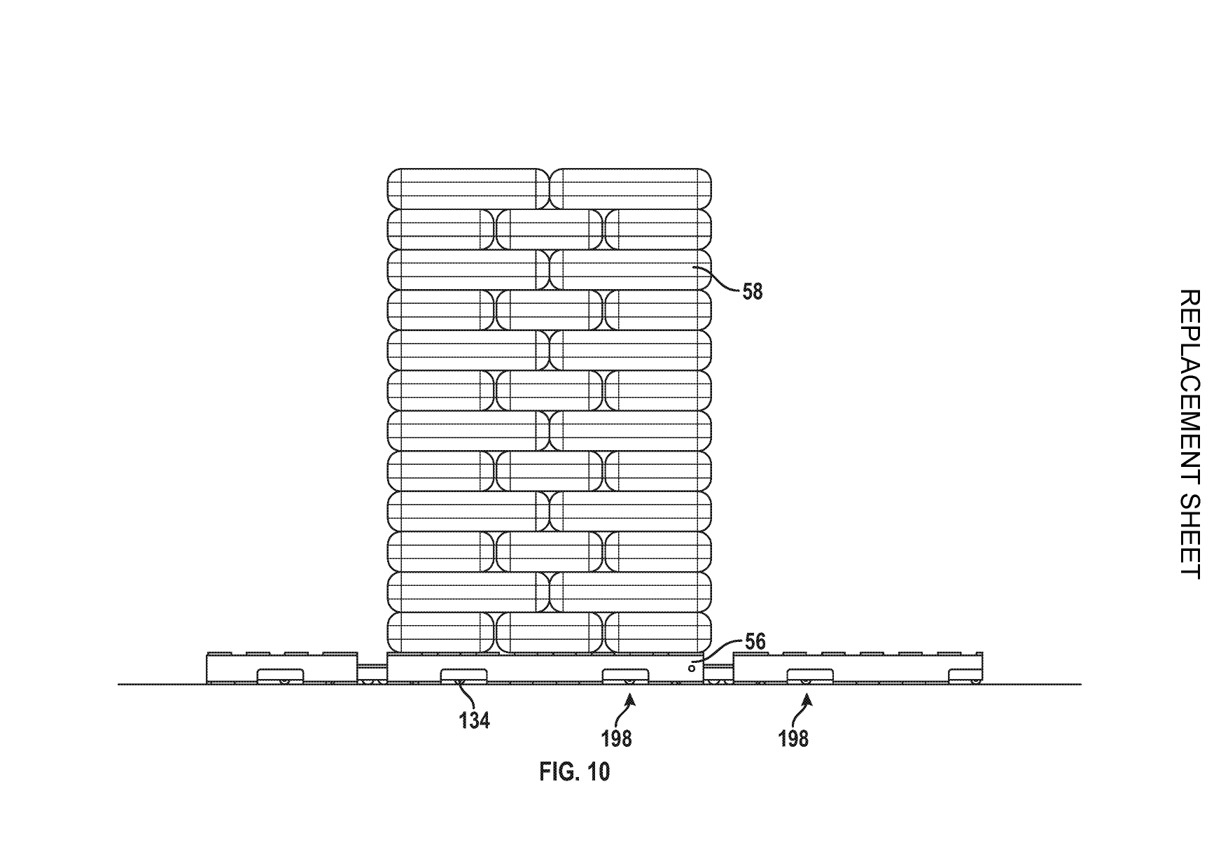

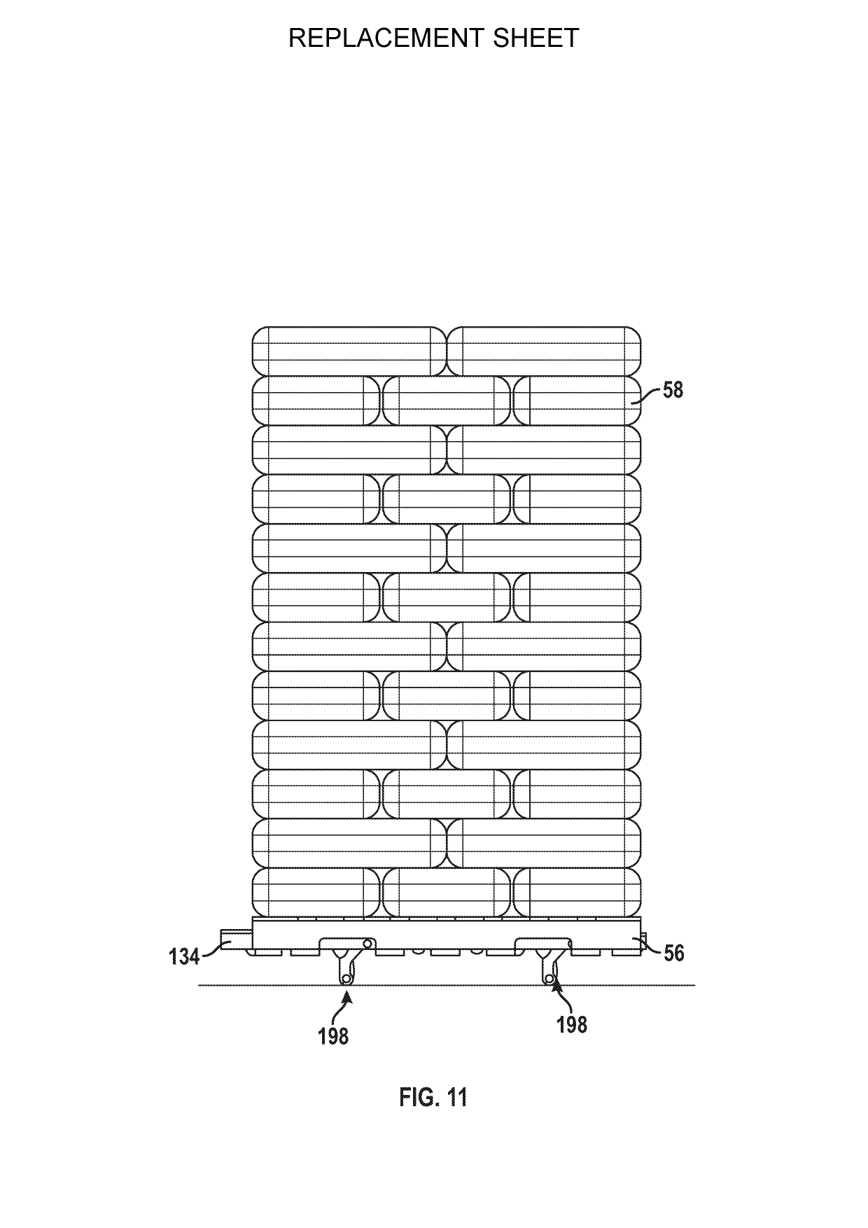

A contact wall 164 having a generally rectangular shape is transverse to the walls 160, 162 and is attached to front edge of each of the second support brackets 156 and rear edge of the first support brackets 154. The contact walls 164 on the front edges of the support brackets 156 contact the support structure (pallet 56) that is adjacent to the drive member 142 and the contact walls on the rear edges of the support brackets 154 contact the drive vehicle, such as the forklift 62, that is used to engage and move the transport assembly 52, which in turn, moves the lift assembly 54 carrying the pallets 56. Also, the main frame 64 of the transport assembly 52 is non-fixedly seated in the spaces 166 formed between the vertically extending walls 162 of the first and second support brackets 154, 156 to enable the drive member 142 to move upwardly and downwardly relative to the main frame 64 during the raising and lowering of the support members 134 between the raised position (FIG. 11) and the lowered position (FIG. 10).

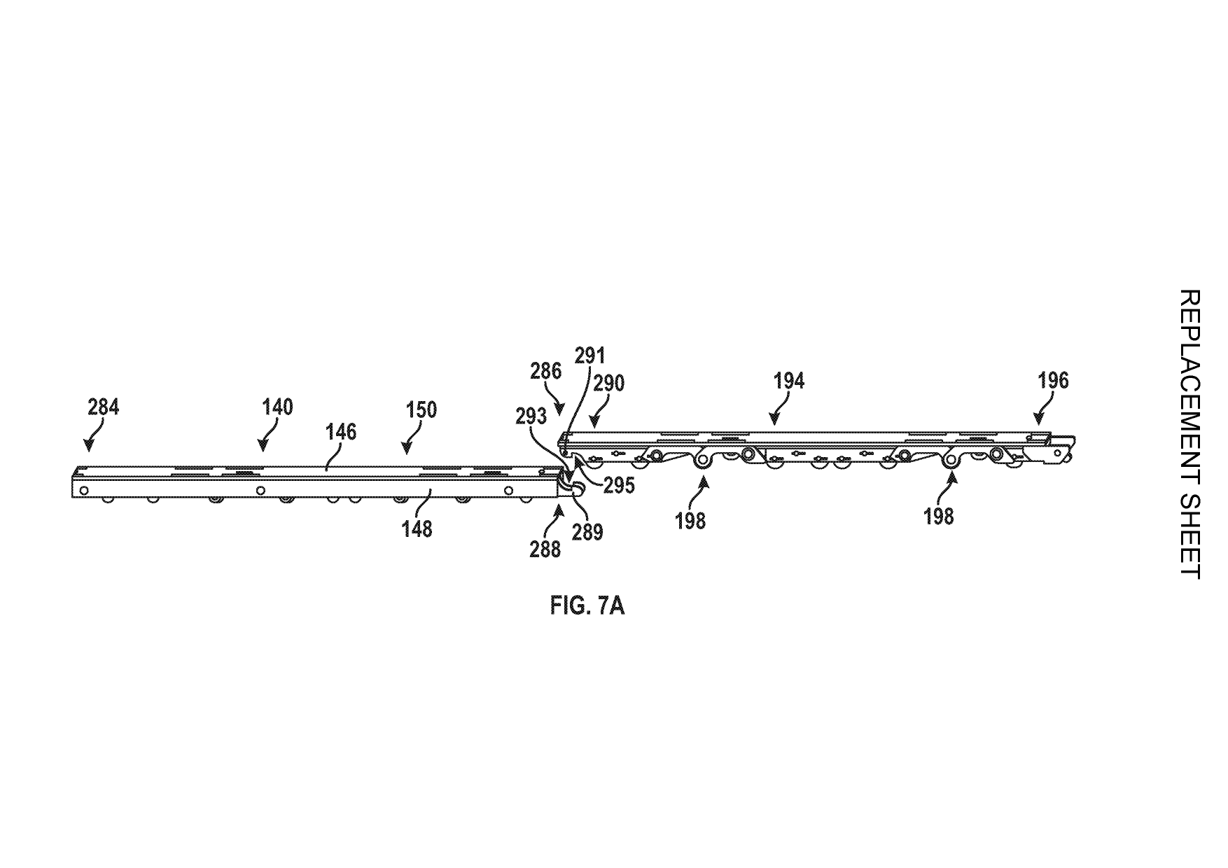

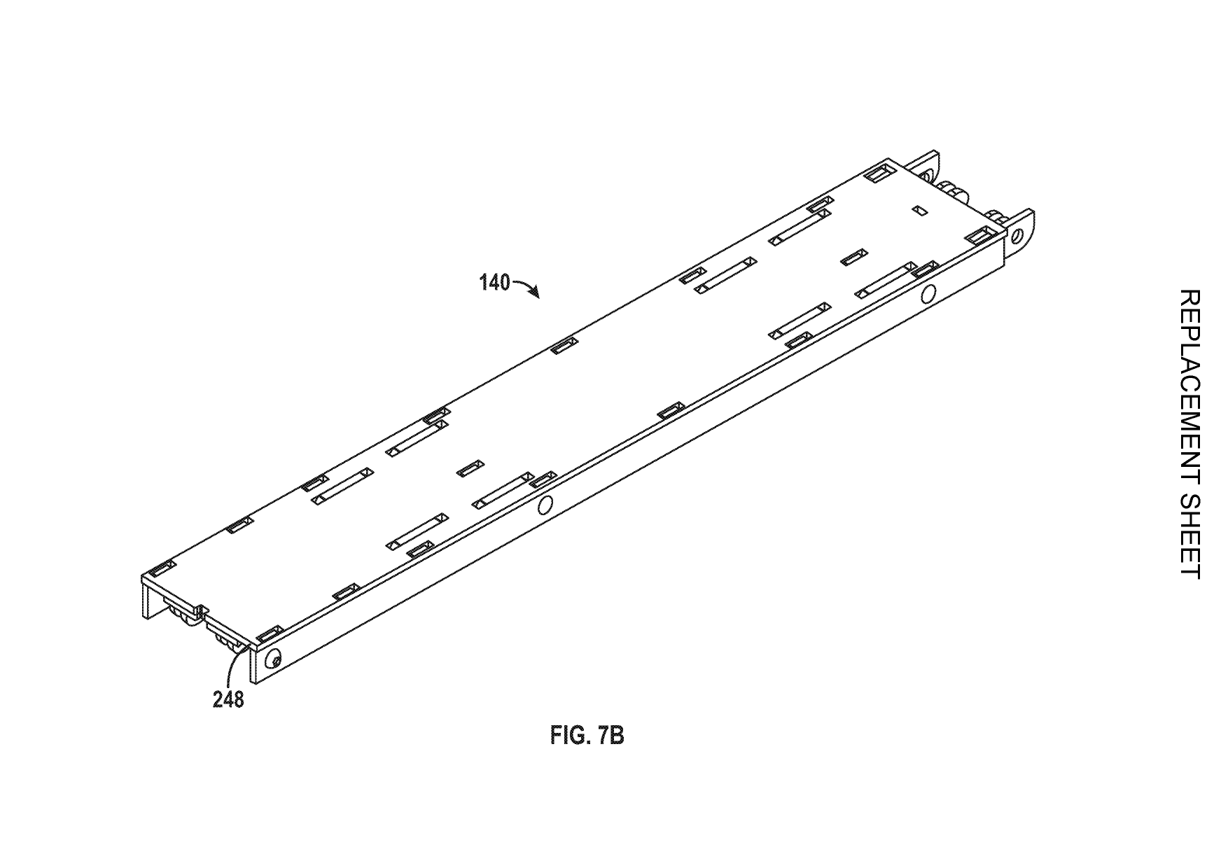

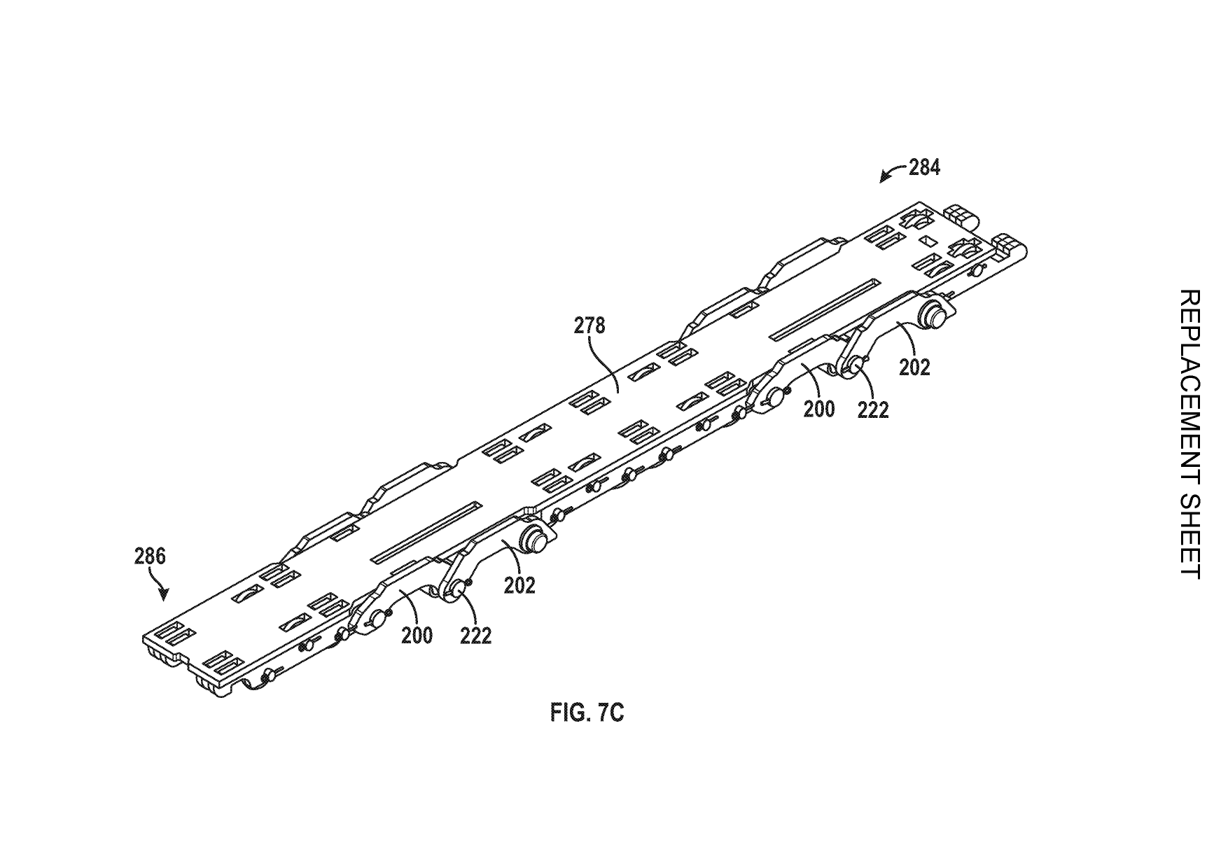

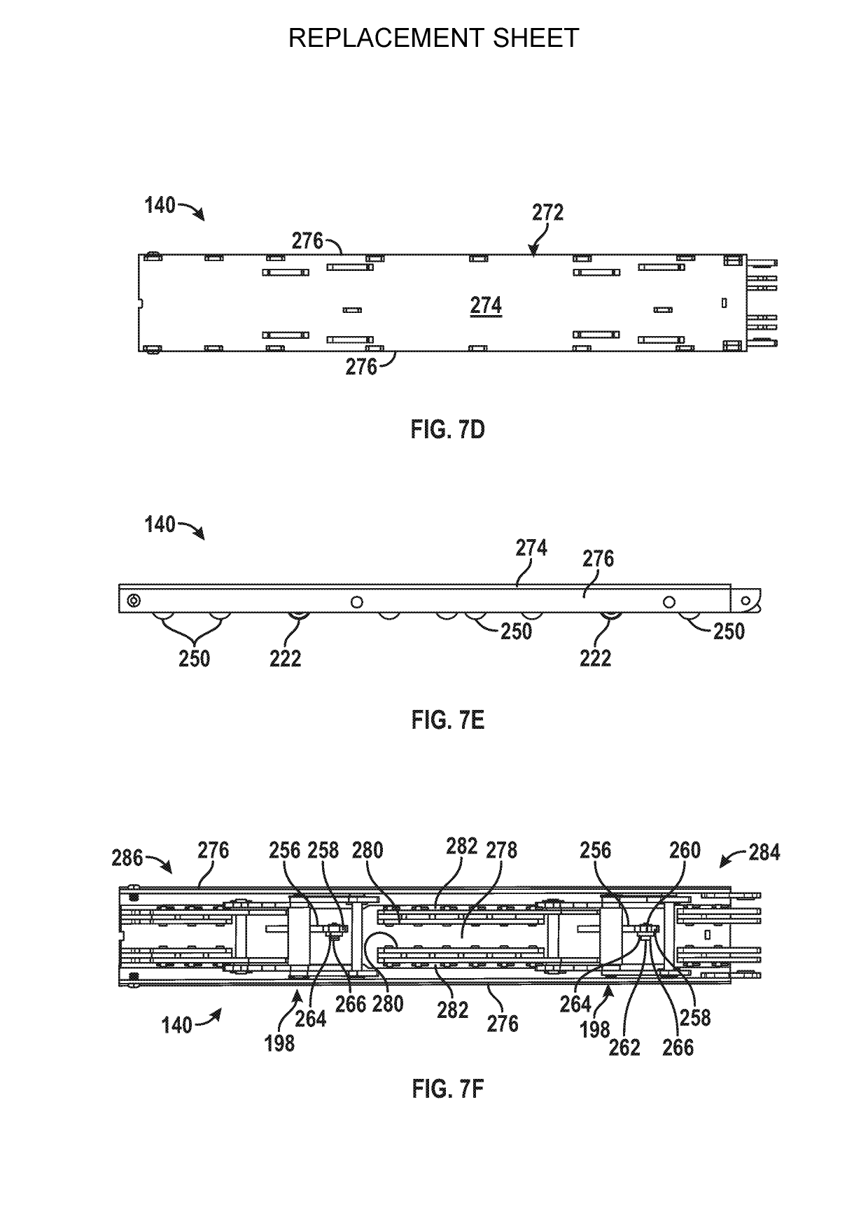

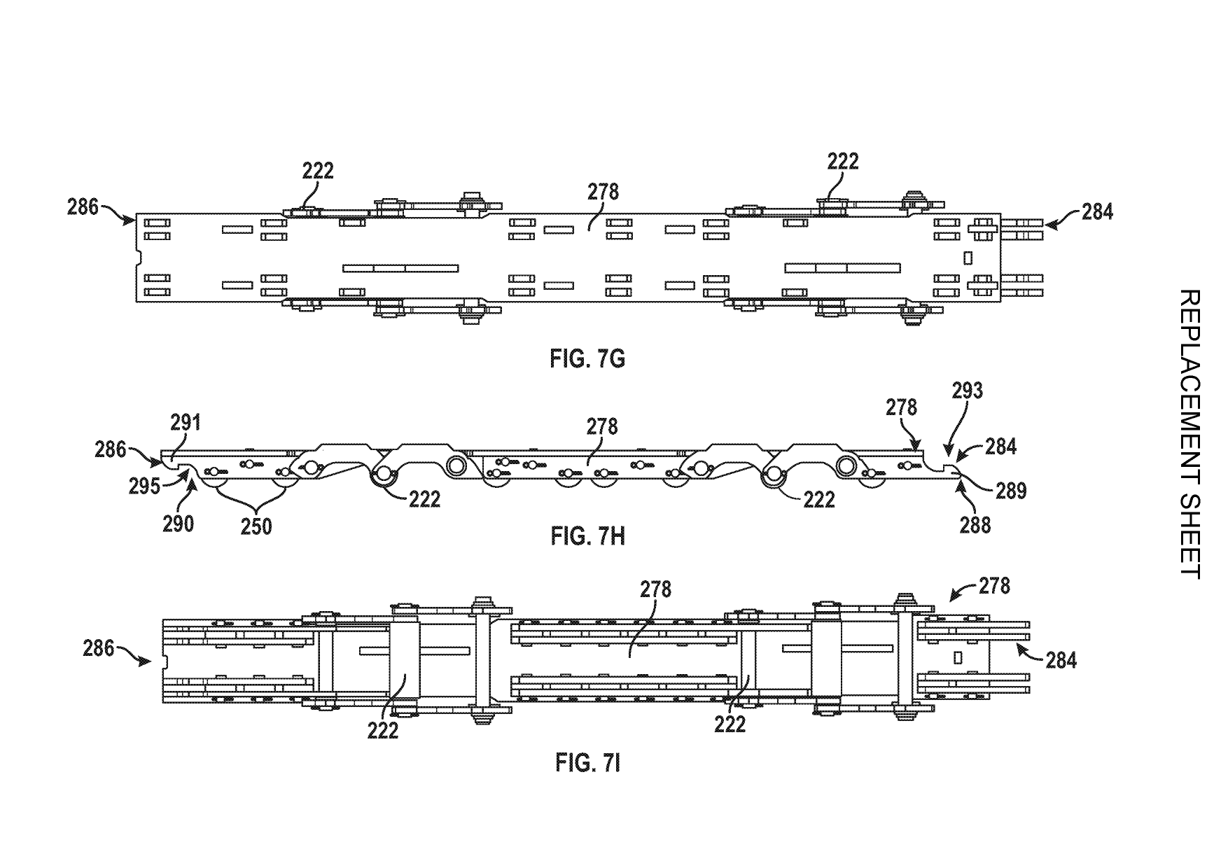

Each of the drive members 142 also includes a hydraulic actuator unit 168 having a front end 170 and an opposing, rear end 172. The hydraulic actuator unit 168 includes a sealed cylinder 174 including a piston and hydraulic fluid (not shown). The front end 170 of the hydraulic actuator unit 168 is fixedly connected to a rod 176 extending between the second support brackets 156. The rear end 172 of each hydraulic actuator unit 168 includes an opening where a piston rod 178 attached to the piston head within the cylinder 174, has an end 180 that extends through the opening and is attached to the rod 176 extending between spaced plate brackets 182. The plate brackets 182 each include a slot 184 configured to receive opposing ends of the rod 176 and enable the position of the rod 176, and thereby the position of the piston rod 178, to be adjusted relative to the plate brackets 184. As shown, the opposing ends of the rod 176 are secured to the plate brackets 184 by a washer and a nut, or by any suitable fasteners. The bottom end 190 of the each of the plate brackets 184 partially extends through slots 192 formed in the top wall of the housing 144 and are attached to an actuator plate 194 (FIG. 7) positioned within the housing 144.

Referring to FIGS. 4-8, the actuator plate 194 has a planar body that is integrally formed by a suitable metal forming process. As shown, the actuator plate 194 is positioned below the top wall 146 of the housing 144, where the width between the outer surfaces of the actuator plate 194 is less than the distance between the opposing sidewalls 148, 150 of the housing 148 so that the actuator plate 194 is able to move relative to the housing 148. The rear end 196 of the actuator plate 194 is positioned at a distance from the end wall 152 of the drive member 142 to enable the actuator plate 194 to move forward and backward relative to the housing 144. In the illustrated embodiment, the hydraulic actuator units 168 are activated to cause the plate brackets 182 to move toward the end wall 152 of the drive member 142, thereby pulling the actuator plate 194 toward the rear end of the drive member 152. When the hydraulic actuator units 168 are deactivated, the plate brackets 182 move toward the front end of the drive member 142, thereby pushing the actuator plate 194 toward the front end of the drive member 142.

As shown in FIGS. 1 and 4, the drive member 142 includes at least one, and preferably three roller assemblies 198 that are spaced from each other along the length (from the front end to the rear end) of the drive member 142, where each of the roller assemblies 198 includes first arms 200 and second arms 202 that are laterally spaced from each other. In the illustrated embodiment, first ends 204 of the first arms 200 are connected to a first rod 206, where the first rod 206 partially extends through through-holes 208 in the first ends 204 and through-holes 210 in outer flanges 212 extending from a bottom surface of the actuator plate 194. As shown, the outer ends of the first rod 206 are secured by pins 216, such as cotter pins, clevis pins or other suitable spring pins or spring collars, to limit the lateral movement of the rod. Second ends 218 of the first arms 200 are connected to mounting posts 220 extending from opposing ends of main roller 222. Similarly, first ends 224 of the second arms 202 have through-holes 226 that align with corresponding through-holes in the sidewalls 148, 150 of the housing 144, where a second rod 228 extends through the through-holes and is secured in place by pins, such as cotter pins, clevis pins or other suitable spring pins or spring collars. Second ends 232 of the second arms 202 are connected to the mounting posts 220 extending from opposing ends of a main roller 222. The mounting posts 220 partially extend through through-holes in the second ends 218 of the first arms 200 and the second arms 202 and are secured to the second ends 218 by a pin or a collar as described above.

The first ends 204 of the first arms 200 are connected to the actuator plate 194 so that the first ends 204 simultaneously move forward and backward with the movement of the actuator plate 194. The second rod 228 forms a pivot point such that the first ends 224 of the second arms 202 are rotatably or pivotably connected to the housing 142 by the second rod 228 and rotate or pivot about the second rod. Similarly, the second ends 218, 232 of the first arms 200 and the second arms 202 rotate or pivot about the ends of the main roller 222.

In operation, when the actuator plate 194 is pulled toward the end wall152 of the drive member 142 as described above, the first ends 204 of the first arms 200 also moves toward the end wall causing the first ends 224 of the second arms 202 to pivot about the second rod 228 and move the second ends 218, 232 and the main roller 222 to move downwardly away from the housing 144 and push against an underlying surface to raise the housing 144 away from the underlying surface. When the actuator plate 194 moves toward the front end of the drive member 142, the first ends 204 of the first arms 200 also move toward the front end of the drive member 142, causing the second ends 218, 232 of the first arms 200 and the second arms 202 and the main roller 222 to move upwardly toward the housing 144, thereby lowering the drive member 142 toward the underlying surface.

The actuator plate 194 also includes plate wheels 234 that have through-holes 236 that align with through-holes in the outer flanges 212 and inner flanges 240 extending from the bottom surface of the actuator plate 194, where each of the plate wheels 234 are secured by a first axle 242 that extends through the aligned through-holes 236, 238 and where a pin 244, such as a cotter pin or similar fastener, is attached to the ends of the first axle 242 to limit the lateral movement of the first axle. As shown, a portion of the plate wheels 234 extends above the top surface 246 of the actuator plate 194 and rolls along the bottom surface 248 of the top wall 146 of the housing 144 so that the actuator plate 194 remains at a designated distance from the bottom surface of the top wall 146 to prevent the actuator plate 194 from contacting the top wall 146 and help reduce wear on the actuator plate and to help prevent the actuator plate from getting contacting and getting stuck on the housing 144 during operation.

Additionally, the actuator plate 194 includes a plurality of ground wheels 250 that have through-holes 252 that align with through-holes 254 in the outer flanges 212 and inner flanges 240 extending from the bottom surface of the actuator plate 194, where each of the ground wheels 250 are secured by a second axle 252 that extends through the aligned through-holes 252, 254 and where a pin 244, such as a cotter pin or similar fastener, is attached to the ends of the second axle 252 to limit the lateral movement of the second axle. As shown, a portion of the ground wheels 250 extends below the bottom surface 254 of the housing 144 so that the ground wheels 250 are spaced from the underlying surface when the drive member 142 is in the raised position and contact the underlying surface when the drive member 142 is in the lowered position. The ground wheels 250 are configured to roll along the underlying surface and over the bottom ends of the pallets 56 to enable the lift assembly 54 to readily move between locations and into and out of the pallets 56.

To maintain the position of the actuator plate 194 (and the actuator plates 278 and 305 described below) within the housing 144, a slot 256 is formed in the actuator plate above each of the roller assemblies 198. A roller flange 258 extends from a bottom surface of the top wall 146 of the housing 144 and through the slot 256. The roller flange 258 includes a through-hole 260 that aligns with a through-hole 262 in a positioning wheel 264. The positioning wheel 264 is rotatably attached to the roller flange 258 by inserting a fastener 266 through the aligned through-holes 260, 262 and secured by fastener 266 or other suitable connector. The roller flange 258 moves between the opposing ends of the slot 256 while the positioning wheel 264 rolls along the bottom surface 254 of the actuator plate 194 during the raising and lowering of the support members 134, to support the actuator plate 194 and to help prevent the actuator plate from moving vertically within the housing 144. It should be appreciated that the drive member 142 may have one positioning wheel 264 or a plurality of the positioning wheels 264.

A plurality of intermediate members 140 are interconnected to each other and connected to the drive member 142. The number of intermediate members 140 that are connected to the drive member 142 depends on the number of the pallets 56 associated with the consolidated unit 60 that will be moved and raised by the lift assembly 54. In an embodiment, one intermediate member 140 is connected to the drive member 142. In another embodiment, two or more of the intermediate members 140 are connected to the drive member 142.

Each of the intermediate members 140 includes a housing 272 having a top wall 274 and opposing sidewalls 276 that are integrally formed together, welded together or connected together by suitable fasteners. Each of the intermediate members 140 includes an intermediate actuator plate 278 and two of the roller assemblies 198 attached to the intermediate actuator plate 278 as described above with respect to the drive member 142. It should be appreciated that the intermediate members 140 may include one of the roller assemblies 198 or a plurality of the roller assemblies 198. Also as described above, the intermediate actuator plate 278 includes inner flanges 280 and outer flanges 282 that extend from a bottom surface of the intermediate actuator plate 278. At least two of the plate wheels 234 and a plurality of the ground wheels 250 are rotatably attached to the inner and outer flanges 280, 282 and are secured by a pin 244. The intermediate actuator plate 278 also includes front and rear inner and outer flanges 280, 282 extending from the bottom of the intermediate actuator plate 278 respectively at a first end or front end 284 and at a second end or rear end 286 of the intermediate actuator plate 278 as shown in FIGS. 7A to 7I. At least one plate wheel 234 and at least two ground wheels 250 are rotatably attached to the front inner and outer flanges 280, 282 and to the rear inner and outer flanges 280, 282 as described above.

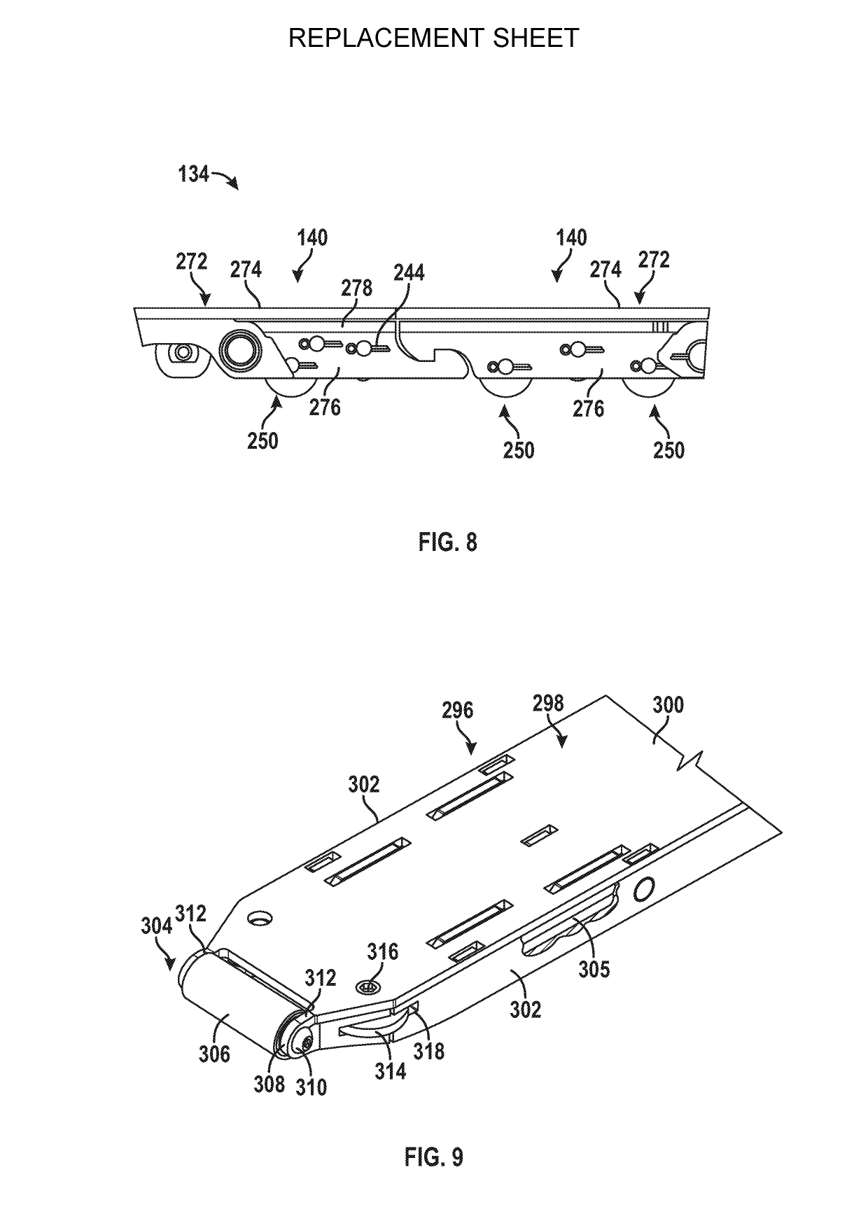

Each intermediate actuator plate 278 also includes an upwardly projecting hook member 288 or a downwardly projecting hook member 290 at the front end 284 and the rear end 286 of the intermediate actuator plate. The upwardly projecting hook member 288 and the downwardly projecting hook member 290 each include a hook 289, 291 and a recess 293 and 295. To securely attach the intermediate actuator plates 278 together and one of the intermediate actuator plates 278 to the drive member 142, the hook 289 of the upwardly projecting hook member 288 matingly engages the recess 295 of the downwardly projecting hook member 290, and the hook 291 of the downwardly projecting hook member 290 matingly engages the recess 293 of the upwardly projecting hook member 288 as shown in FIG. 8. In this way, the actuator plate 194 of the drive member 142 is securely connected to the intermediate actuator plates 278 of each of the intermediate members 140 to simultaneously move the actuator plates 194, 278 in a forward or rearward direction. The raising and lowering of the intermediate members 140 by the wheel assemblies 70 is the same as described above for the drive member 142. In operation, the drive member 142 simultaneously moves all of the actuator plates 194, 278 to move the wheel assemblies 70, and thereby raise and lower the drive member 142 and the intermediate members 140.

Referring to FIGS. 1 and 9, the support members 134 each include an end member 296 having a housing 298 formed by a top wall 300 and opposing sidewalls 302 that are integrally formed together, welded together or attached together by suitable fasteners. The end member 296 is the same as the intermediate member 140 except that an end, i.e., the front end 304 includes guide rollers such as vertical guide roller 306 supported by an axle 308 where the ends of the axle 308 extend through through-holes 310 in spaced roller brackets 312 on the end the housing 298. The vertical guide roller 306 rotates in a clockwise or counterclockwise direction and helps the front end 304 of each end member 296 roll along a vertical wall of a container when the lift assembly 54 is moving raised or lowered inside of a container. Also, each sidewall 302 of the end member 296 includes a lateral guide roller 314 that are adjacent to the vertical guide roller 306 and are rotatably attached to a post 316 secured to the housing 298. The lateral guide rollers 314 rotate in a clockwise or counterclockwise direction about vertical longitudinal axes, where a portion of each of the lateral guide rollers 314 extends through slots 318 formed in the sidewalls 302. This enables the lateral guide rollers 314 to contact and roll along the inner surfaces of the sidewalls of a container to help facilitate movement of the lift assembly 54 into and out of a container or similar storage container or shipping container. It should be appreciated that the end member 296 may have one lateral guide roller 314 or a plurality of lateral guide rollers 314 on the sidewalls 302. In this embodiment, the end member includes an end actuator plate 305 that is connected to the intermediate actuator plate 278 of the adjacent intermediate member 140 and moves relative to the housing 298, and roller assemblies 198 that operate as described above.

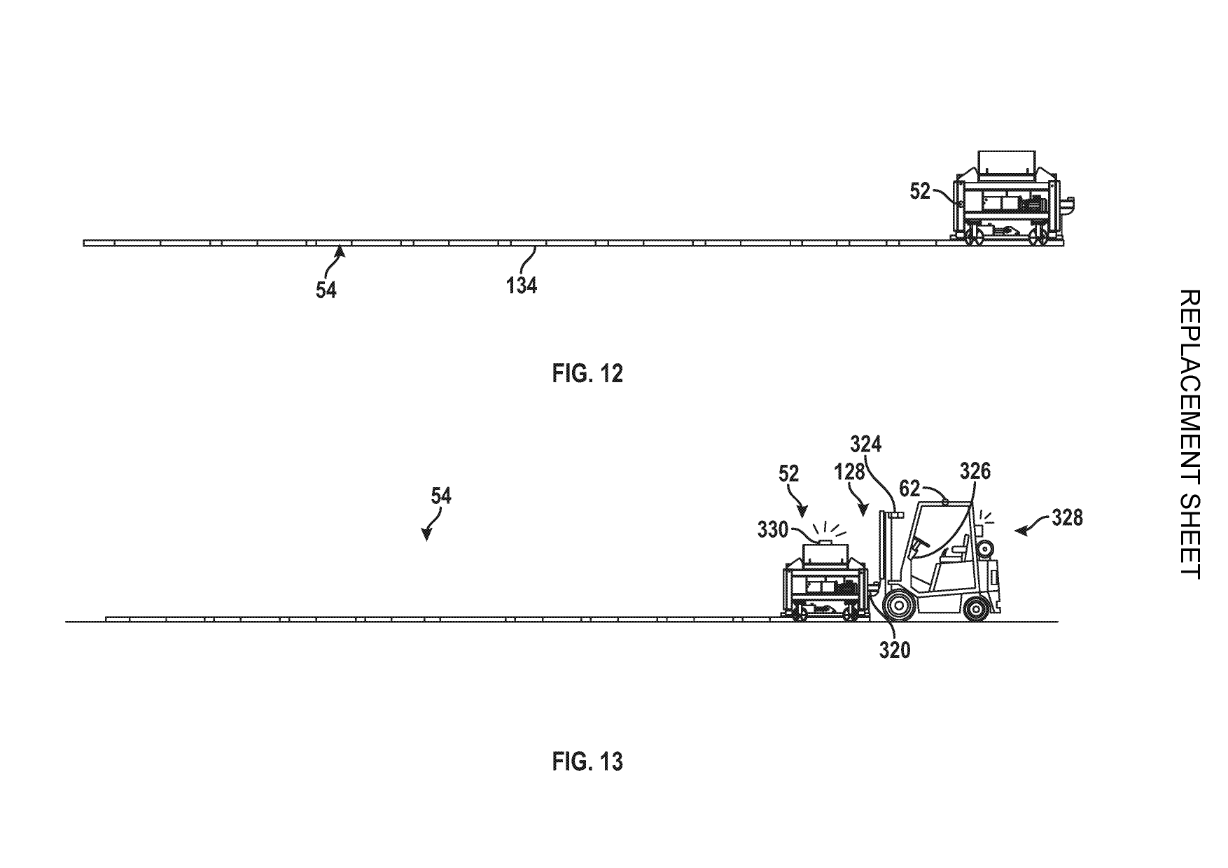

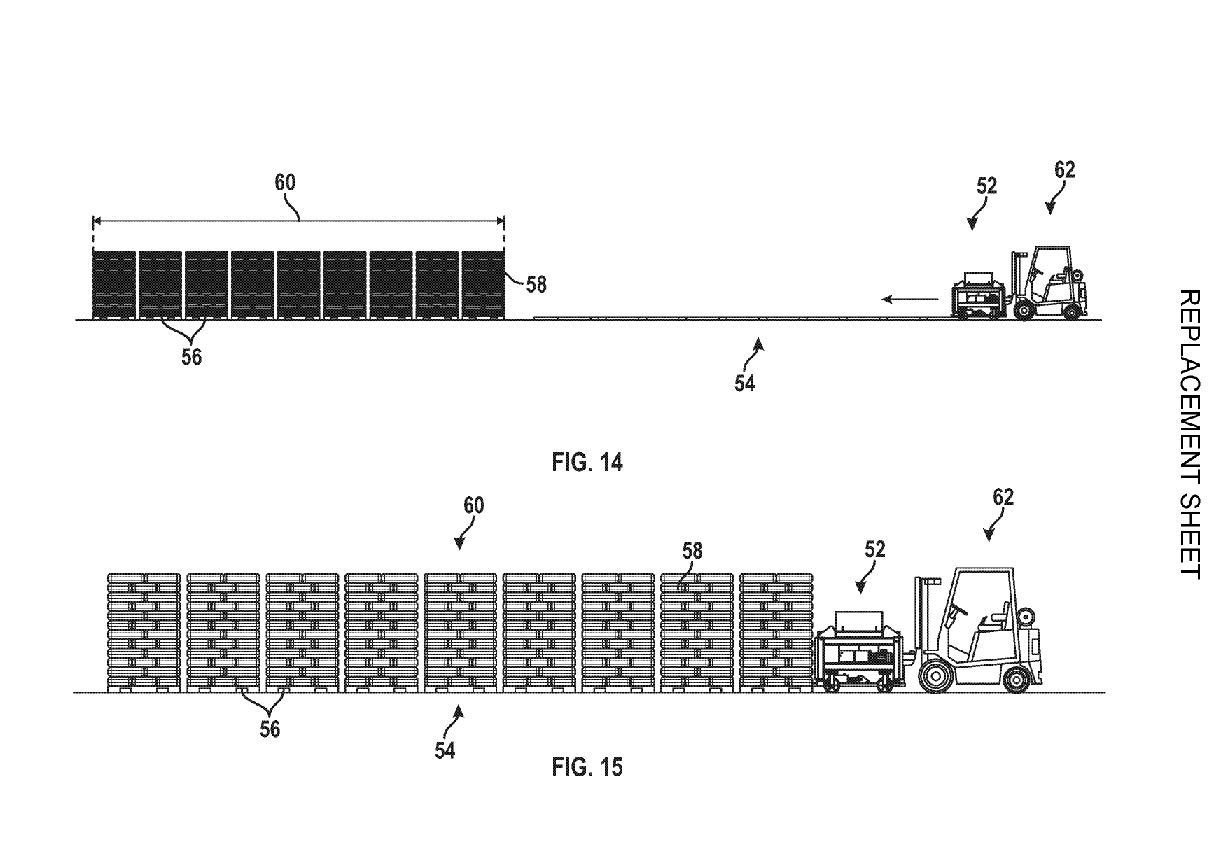

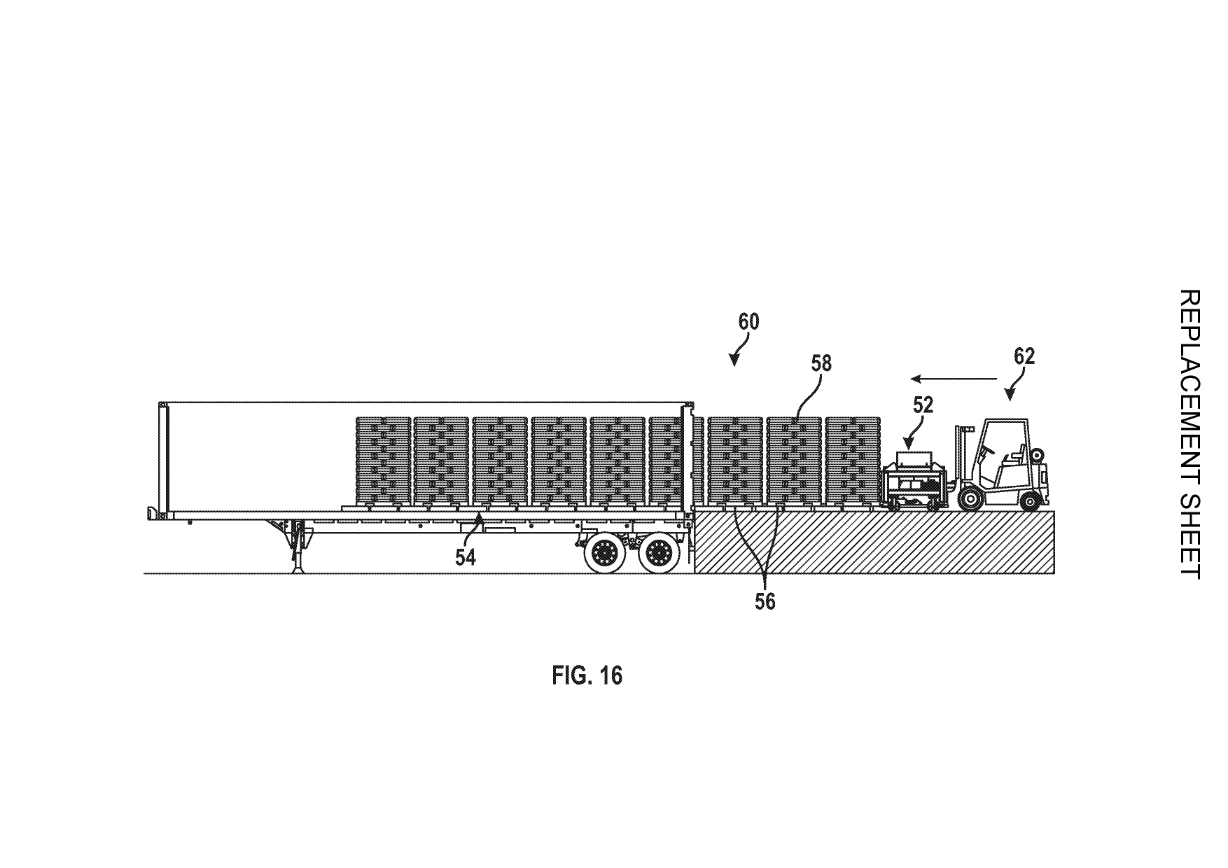

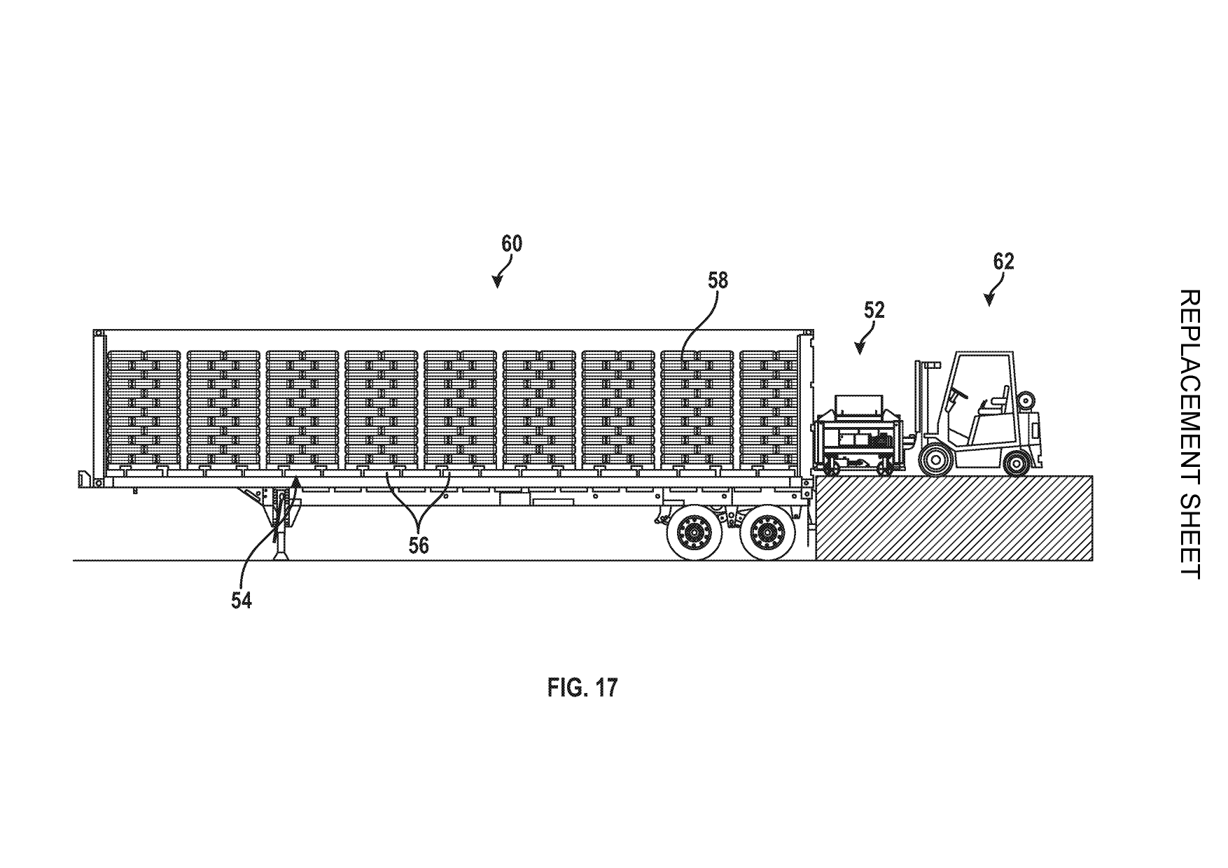

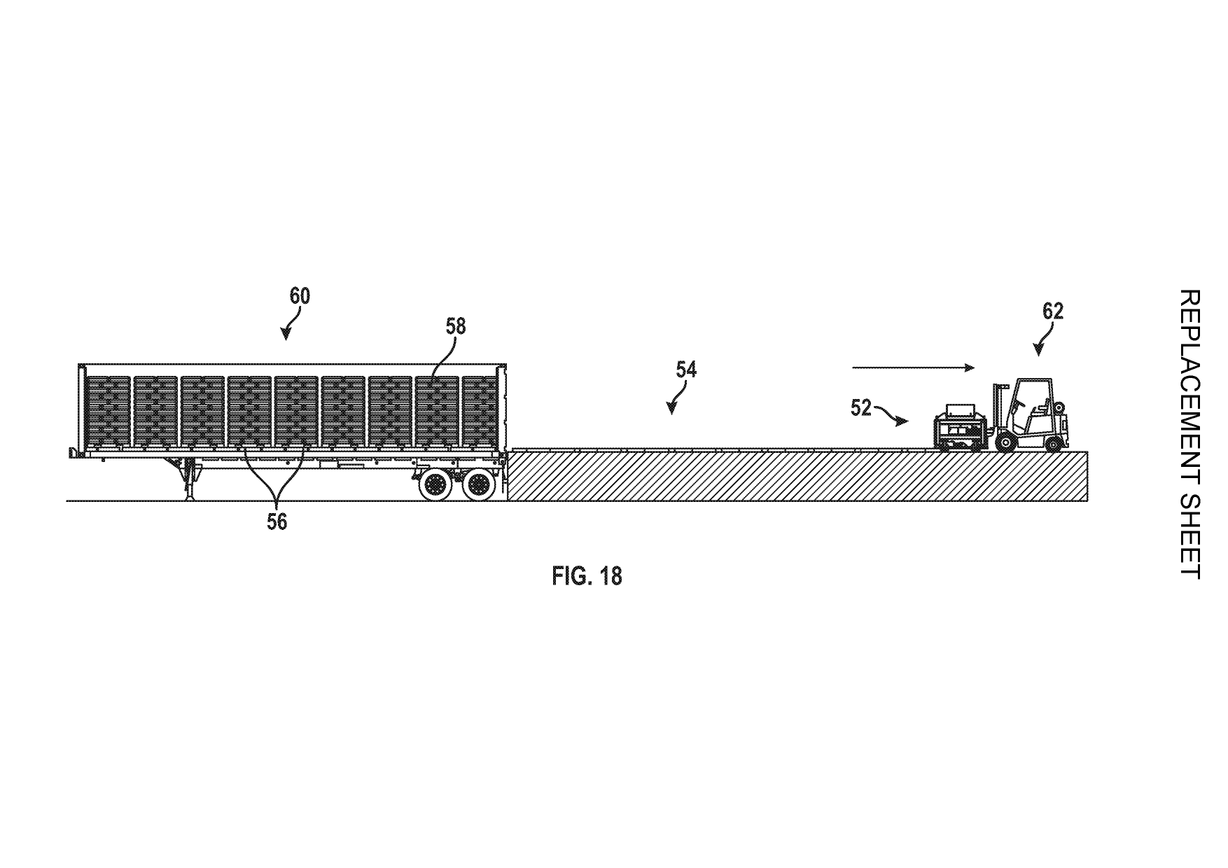

Referring to FIGS. 12-18, in operation, a drive vehicle, such as forklift 62, aligns the forks 320 with the fork openings 322 on the rear end of the transport assembly 52 and moves the forklift 62 toward the transport assembly 52 until the fork support 324 contacts the rear end of the transport assembly 52. The fork support 324 and forks 320 are then lowered so that the bottom of the fork support 324 is positioned between the stop member 132 of the transport connector 129 and the rear end of the transport assembly 52. This helps to maintain the connection between the forklift 62 and the transport assembly 52 during movement.

Once the forklift 62 is connected to the transport assembly 52, the forklift 62 moves the transport assembly 52 and the lift assembly 54 toward a consolidated unit 60 consisting of a plurality of support structures, such as pallets 56, where the pallets 56 are each holding a plurality of products. The support members 134 are aligned with the through-holes at the bottom of the pallets 56 and then the forklift 62 moves the forks 320 into and through the through-holes at the bottom of each of the pallets 56 until the front end of the lift assembly 54 exits the through-holes on the last pallet 56, i.e., the pallet furthest from the forklift. As the support members 134 of the lift assembly 54 move through the through-holes in the pallets 56, the ground wheels 250 and lateral guide rollers 314 engage and roll along corresponding surfaces on the pallets 62 to facilitate movement of the support members 134 through the through-holes in the pallets 56. After the fork support 324 of the forklift 62 is adjacent to the first pallet 56, i.e., the pallet closest to the forklift, the forklift 62 begins the process of raising the consolidated unit 60 of pallets 56.

To raise the consolidated unit 60 of pallets 56, an operator in the forklift 62, activates a button or switch on the forklift control panel 326 (FIG. 13), which causes a wireless transceiver 328 to send a signal to a receiver 330 on the transport assembly 52 to raise the support members 134. After the receiver 320 receives the signal, the hydraulic power units 126 activate the hydraulic actuator units 168 to pull the interconnected actuator plates 194, 278 and 305 within the support members 134, toward the rear end of the transport assembly 52 (toward the forklift 62). Pulling the interconnected actuator plates, causes the roller assemblies 198 to move from a first position or lowered position to a second position or raised position, in which the pallets 56 and products of the consolidated unit 60 are raised away from the underlying surface. Once in the raised position, the forklift 62 moves the consolidated unit 60 to a desired location within a facility or within a storage or shipping container of a transport vehicle, such as a truck.

After the consolidated unit 60 is at the desired location or completely moved into the container, the operator again activates the button or switch on the control panel 326, which sends a signal from the transceiver 328 on the forklift 62 to the receiver 330 on the transport assembly 52, to lower the support members 134 of the lift assembly 54, and thereby the consolidated unit 60. The roller assemblies 198 move toward the support members 134, which causes the support members 134 to move toward the underlying surface until the lift assembly 54 is in the lowered position. Once in the lowered position, the forklift 62 moves away from the consolidated unit 60, which causes the support members 134 of the lift assembly 54 to move outwardly through the through-holes of the pallets 56 until the support members 134 are completely removed from the through-holes of the pallets 56. The forklift 62 may now be used to move another consolidated unit 60 within a facility or into the same storage container or a different storage container.

To remove a consolidated unit 60 of pallets 56 from a container, such as a storage container, the forklift 62 aligns the support members 134 of the lift assembly 54 with the through-holes of the pallets 56 of the consolidated unit 60 and then moves the support members 134 through the through-holes until the fork support 324 is engaged with the transport connector 129 and the front ends of the support members 134 are at least partially through the last pallet 56 of the consolidated unit 60. The operator of the forklift 62 then activates the button or switch on the control panel 326, which sends a lift signal from the transceiver 328 to the receiver 330 on the transport assembly 52. This causes the hydraulic power units 126 to activate the hydraulic actuator units 168 associated with the support members 134 to move the support members 134 from the lowered position to the raised position. Once in the raised position, the forklift 62 moves the consolidated unit 60 of pallets 56 out of the storage container to another location within the facility, into another storage container or to any suitable location.

As described above, the present loading and unloading apparatus 50 enables a user to move a large number of pallets 56 having products (a consolidated unit 60) simultaneously between locations and into and out of storage and shipping containers. Efficiently moving a plurality of pallets holding products at the same time, saves significant time and money over conventional methods of individually moving the same pallets with products.

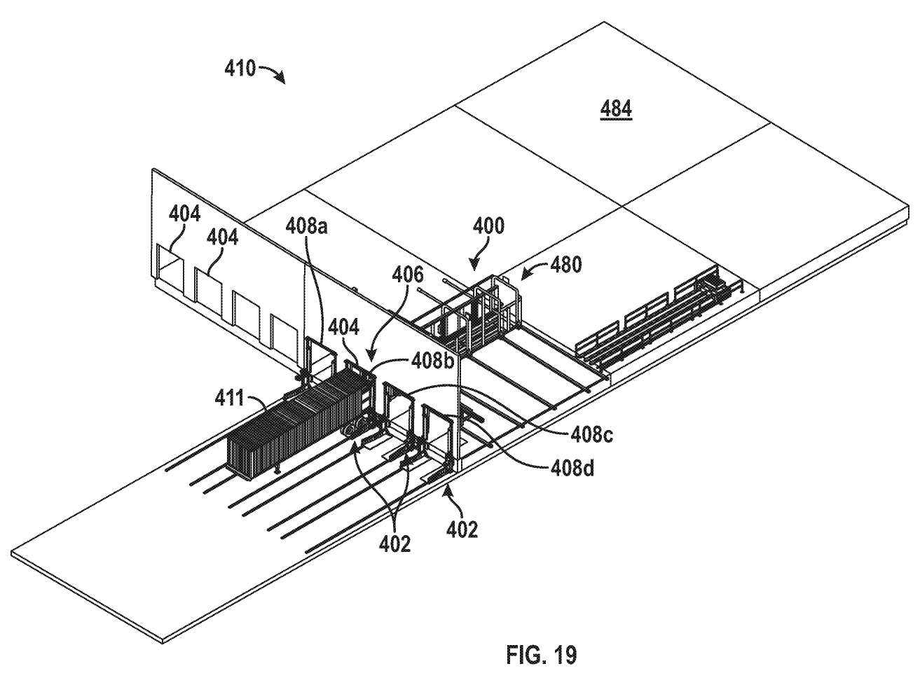

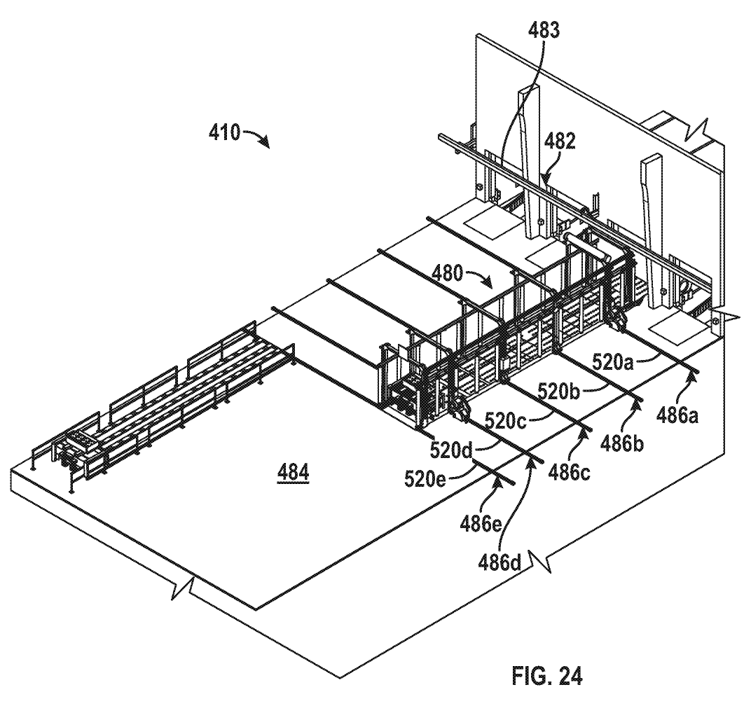

Referring to FIGS. 19 to 24, an embodiment of transport system is shown where the transport system 400 includes a container alignment apparatus 402 fixed to the ground by a door opening 404 of a door 406 at one or more docking stations 408 at a facility 410. In the illustrated embodiment, the facility 410 includes four docking stations 408a, 408b, 408c and 408d that are associated with corresponding doors 406 (door openings) at the facility where shipping containers 411 transported by trucks or other transport vehicles are moved into position relative to the doors 406 as shown in FIG. 19. As described above, the shipping containers 411 are configured to receive a plurality of pallets that each carry products. Each of the four docking stations 408a, 408b, 408c and 408d includes the container alignment apparatus 402.

Each container alignment apparatus 402 includes a frame 412 having two vertical supports 414, a cross support 416 connected to upper ends of the vertical supports 414 and base members 418 connected to lower ends of the vertical supports 414. The vertical supports 414 each include upper flanges 420 and opposing, lower flanges 422 where the upper and lower flanges each include receptacles 424. Guide rollers 426 are movably attached to the vertical supports 414 where each guide roller has a cylindrical body 428 with posts 430 extending from opposing ends of the body. The posts 430 on the opposing ends of the body 428 engage the corresponding receptacles 424 in the upper and lower flanges 420 and 422 on the vertical supports 414. The posts 430 are configured to rotate within the receptacles 424 so that the guide rollers 426 rotate relative to the vertical supports 414. The base members 418 each include a base plate 432 that has a substantially rectangular shape and a guide wall 434 extending from a surface of the base plate, where each guide wall 434 has an angled portion 436 and a straight portion 438. Triangular flanges 440 are attached to bottom ends of the vertical supports 414 and attached to ends of the guide walls 434 and the base plates 432. The triangular flanges 440 provide rigidity and support to the frame 412. In use, the base plates 432 of the base members 418 are secured to the underlying surface, i.e., the ground, using fasteners, adhesive, a combination of fasteners and adhesive or any suitable securing method.

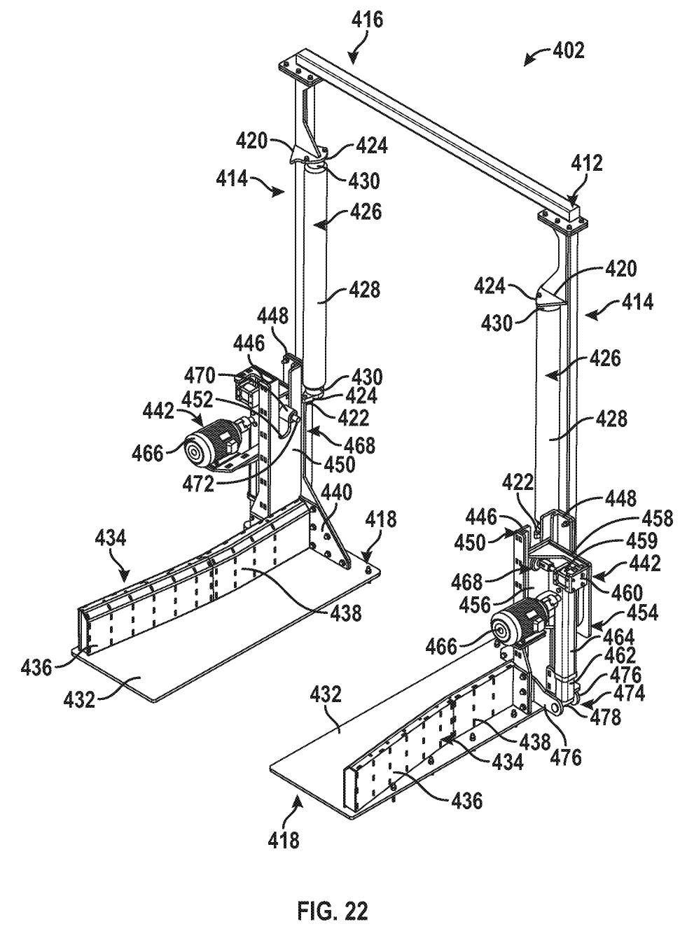

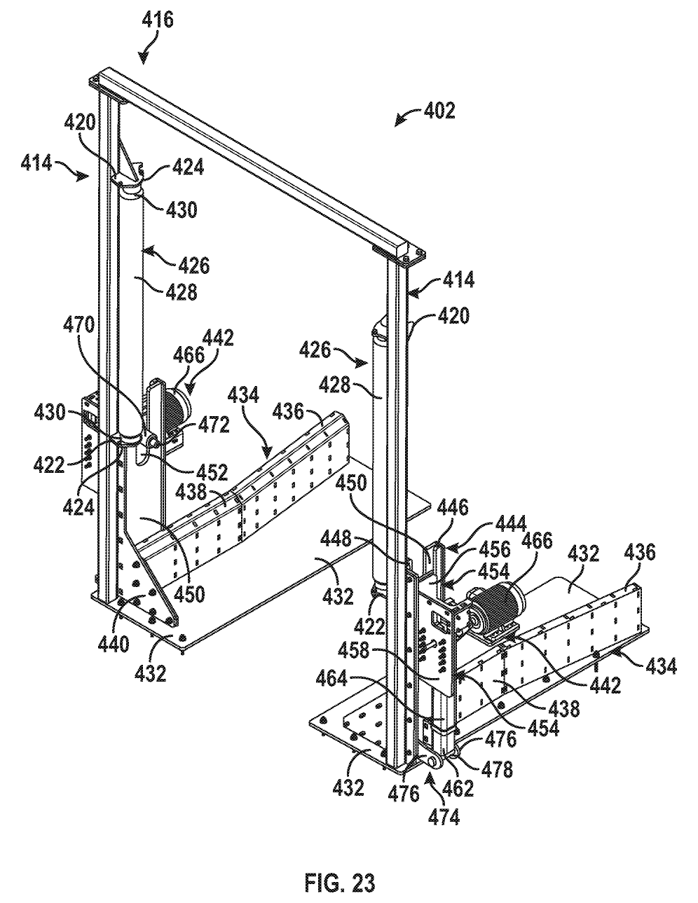

Additionally, each container alignment apparatus 402 includes adjustment mechanisms 442 attached to the vertical supports 414 and the base plates 432, where the adjustment mechanisms 442 are positioned adjacent to outer surfaces of the guide walls 434 as shown in FIGS. 22 and 23. Each adjustment mechanism 442 includes a support frame 444 having opposing sidewalls 446 and 448 and a front wall 450 extending between the sidewalls. As shown, the front walls 450 each include u-shaped slots 452 extending from top ends of the front walls 448. Guide brackets 454 are positioned adjacent to the support frames 444, where the guide brackets 454 include front guide walls 456 that extend between inner surfaces of corresponding sidewalls 446, 448 of the support frames and side guide walls 458 that are transverse to the front guide walls 456 and positioned adjacent to the inner surfaces of the sidewalls 446, 448 of the support frames 444. The front guide walls 456 and the side guide walls 458 are configured to slide relative to the inner surfaces of the sidewalls 446, 448 of the support frames 444. An upper post support 460 is attached to each of the side guide walls 458 and a lower post support 462, and posts 464 extend between and are secured to the upper post support 460 and the lower post support 462. Further, motors 466 are secured to the side guide walls 458 using suitable fasteners. The adjustment mechanisms 442 each include moving devices 474 having opposing arms 476 and bars 478 extending between the arms, where the bars 478 are positioned below the lower post supports 462. The opposing arms 476 of the moving devices 474 are pivotably attached to the support frame 444 and coupled to the motors 466.

Alignment pin assemblies 468 each include a housing 470 and a pin 472 movably attached to the housing where the pins 172 are coupled to air cylinders 459, such as pneumatic air cylinders. The air cylinders 459 receive compressed air from a air supply source (not shown) to cause the pins 472 to move outwardly and the compressed air is released from the air cylinders to cause the pins 472 to move inwardly relative to the front guide walls 456.

During operation, the air cylinders 459 receive compressed air and cause the corresponding pins 472 to move outwardly to engage the frame of a shipping container 411 to secure the shipping containers in position relative to the door openings 404. After the pins 472 are engaged with the shipping containers 411, the motors 466 cause the moving devices 474 to pivot and move the posts 464 and the corresponding guide brackets 454 upwardly or downwardly relative to the base members 418 to adjust the vertical height of the shipping containers 411 relative to the door openings 404.

Referring to FIGS. 19, 20 and 24 to 26, an embodiment of the transport system is shown where the transport system 400 includes a transport apparatus 480 coupled to an electrical assembly 482, where the transport apparatus 480 moves along a floor 484 of the facility 410 via a plurality of tracks 486a, 486b, 486c, 486d and 486e. The electrical assembly 482 is connected to a main power supply at the facility 410 and includes a cage member 483 secured to an inner surface of a wall by the docking stations 408 at the facility 410. The cage member 483 includes several electrical cables/wires that are coupled to the main power supply and coupled to and move with the transport apparatus 480 to provide electrical power to the transport apparatus 480.

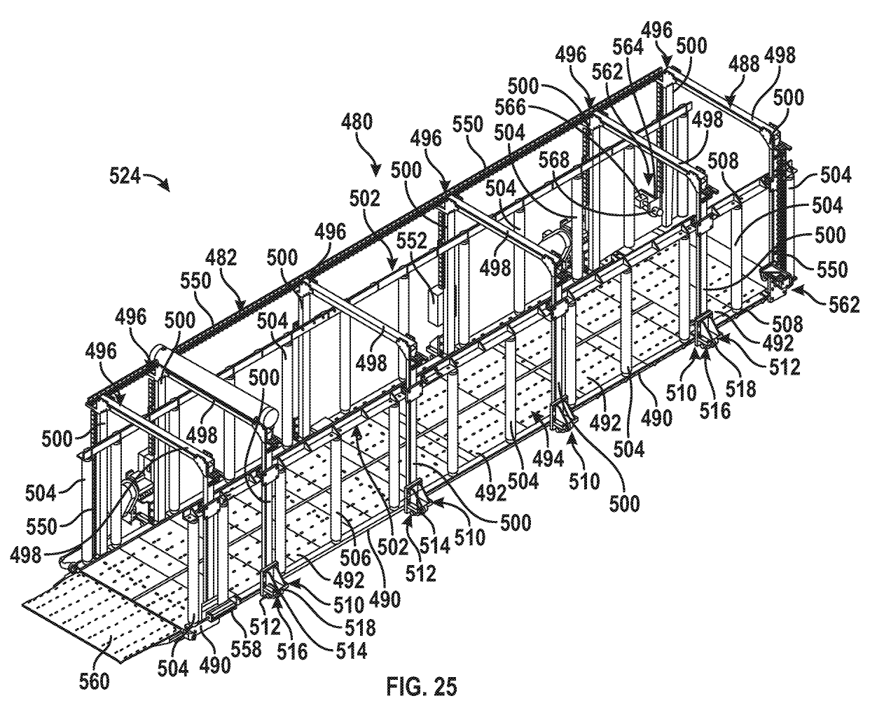

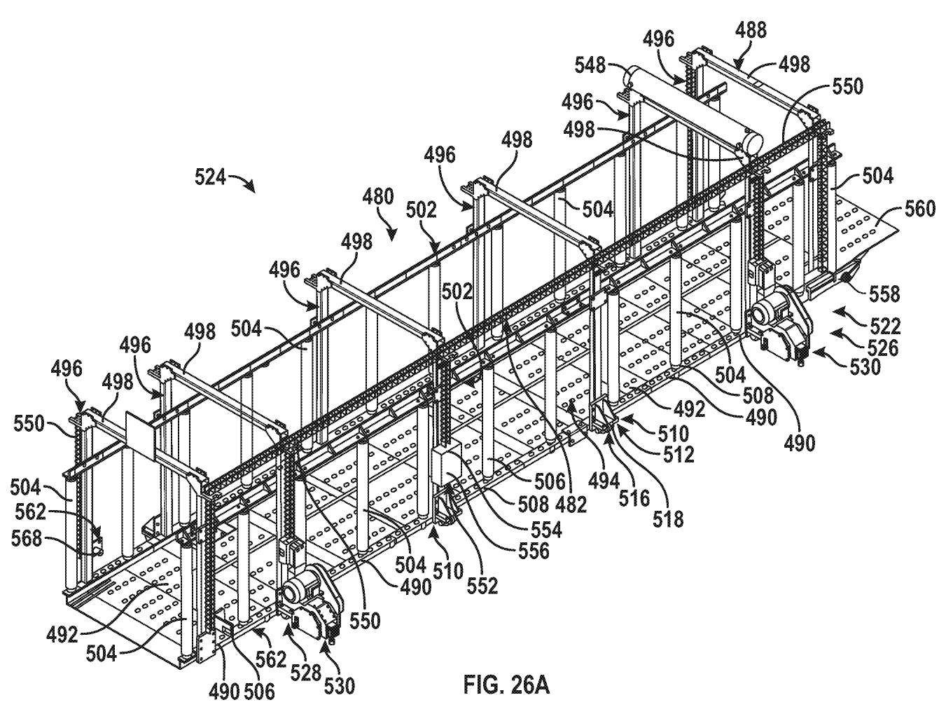

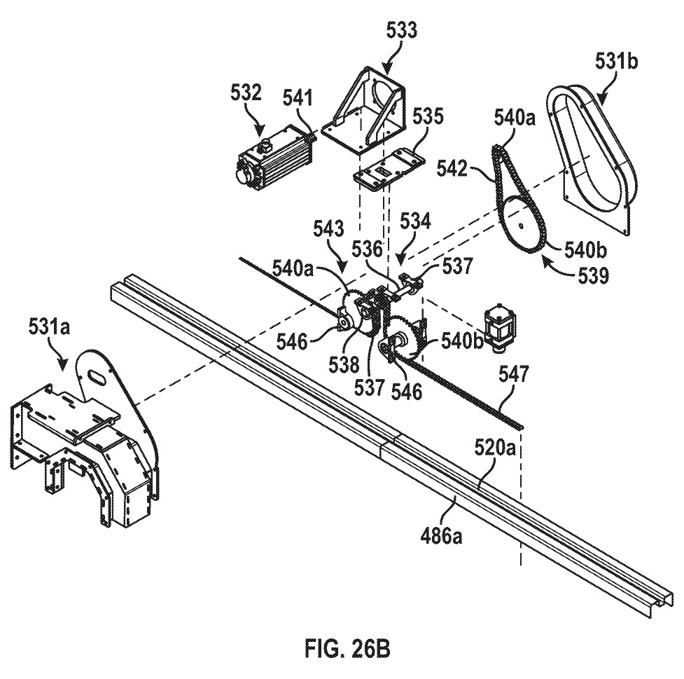

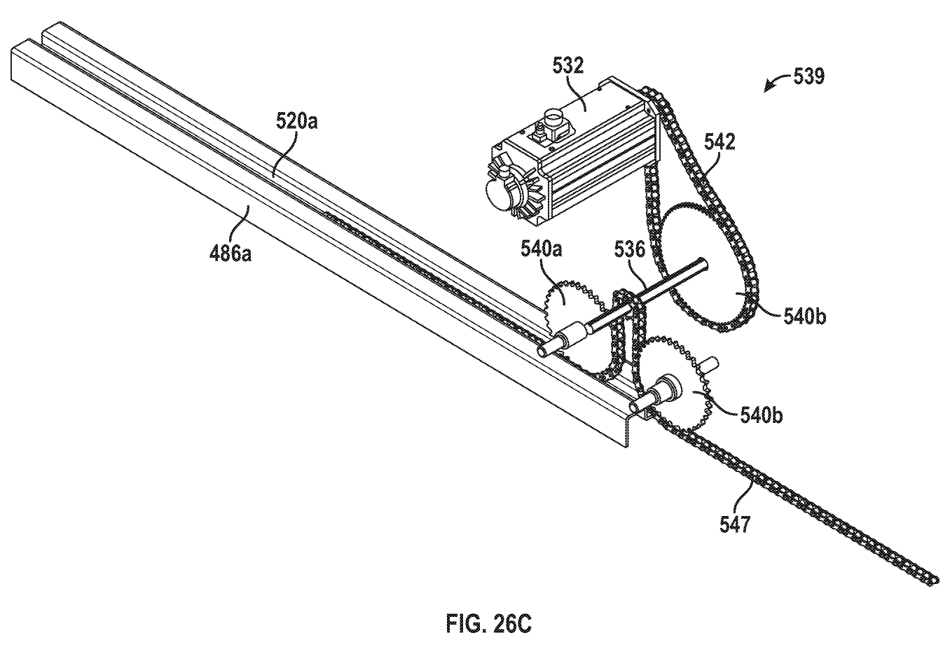

The transport apparatus 480 includes a frame 488 including bottom supports 490 that are spaced apart along a length of the frame, and floor plates 492 that are placed on and secured to the bottom supports 490 to form the bottom wall or floor 494 of the transport apparatus 480. As shown, a plurality of u-shaped support members 496 each have a cross support 498 and two vertical supports 500 attached to opposing ends of the cross support 498, where bottom ends of the vertical supports 500 are attached to floor 494 of the transport apparatus 480 using fasteners, welding or a combination of fasteners and welding. The u-shaped support members 496 are spaced along the length of the transport apparatus 480 as shown in FIGS. 25 and 26. Specifically, one of the u-shaped support members 496 is placed at a first end of the frame 488, another one of the u-shaped support members 496 is placed at the opposing second end of the frame 488 and four of the u-shaped support members 496 are placed between the u-shaped support members at the first end and the second end of the frame 488. The u-shaped support members 496 form sidewalls of the frame 488 and provide structural rigidity and support to the transport apparatus 480.

The frame 488 further includes opposing upper supports 502 that extend along the length of the frame are attached to each of the u-shaped support members 496 by fasteners and/or welding. As shown, the ends of the upper supports 502 extend outwardly from the u-shaped support members 496 at the first end and the second end of the frame 488. A plurality of rollers 504 are attached to the upper supports 502 and the floor 494. Each roller 504 includes a cylindrical body 506 having a first diameter and posts 508 extending from opposing ends of the body, where the posts 508 each have a diameter that is less than the diameter of the body 506. The posts 508 on the opposing ends of each of the rollers 504 engage corresponding receptacles or through-holes 510 formed in the upper supports 502 and in the floor 494. Two of the rollers 504 are located at the first end and at the second end of the frame 488, and then the remaining rollers 504 are spaced along the length of the frame on opposing sides of the frame 488. The rollers 504 are positioned so that the outer surfaces of the bodies 506 extend at least partially inwardly from inner surfaces of the u-shaped support members 496.

A plurality of roller assemblies 510 are attached to the frame 488 to facilitate movement of the transport apparatus 580 along the floor 484 of the facility 410. Each roller assembly 510 includes an L-shaped bracket 512 with spaced triangular support flanges 514 and downwardly extending roller flanges with aligned through-holes. A plurality of rollers 516 each including a cylindrical body 518 and posts (not shown) extending outwardly from ends of the body, where the rollers 516 are rotatably attached to the roller flanges 514 by engaging the opposing posts of the bodies with the aligned through-holes in the roller flanges 514. The rollers 516 each have a width configured to engage corresponding channels formed in the tracks.

In the illustrated embodiment, a first side 522 of the transport apparatus 580 includes a first drive assembly 526 attached to one of the u-shaped support members 496, two of the roller assemblies 510 attached to corresponding u-shaped support members 496 and a second drive assembly 528 attached to another one of the u-shaped support members 496. The first and second drive assemblies 526 and 528 each include a housing 530, where the housing includes a first housing part 531a and a second housing part 531b that are attached together by fasteners. In both the first and second drive assemblies, a motor 532 is attached to an L-shaped motor platform 533 that is secured to a top surface of the first housing part 531a by fasteners. A chain support assembly 534 includes a support plate 535 and a drive rod 536, where the support plate 535 is attached to an inner surface of the first housing part 531a by fasteners. A plurality of brackets 537 are secured to the support plate 535, where the brackets 537 include through-holes 538 that are aligned with each other and are configured to receive the drive rod 536. A drive mechanism 539 is coupled to the drive rod 536 and includes a first sprocket 540a and a second sprocket 540b that are spaced from each other, where the first sprocket is attached to a drive rotor 541 of the motor 532 and the second sprocket 540b is attached to an end of the drive rod 536. In the illustrated embodiment, the first sprocket 540a has a diameter that is less than a diameter of the second sprocket 540b. It should be appreciated that the first sprocket 540a and the second sprocket 540b may have any suitable diameters. As shown, a drive chain 542 extends over the first sprocket 540a and the second sprocket 540b, where the second housing part 531b encloses the drive mechanism 539 when the second housing part 531b is secured to the first housing part 531a.

In operation, a user presses a button on the main control box describe below to activate the motors 532 of the first and second drive assemblies 526 and 528 and rotate the drive rotors 541, which in turn, rotates the first sprockets 540a. The rotation of the first sprockets 540a simultaneously rotates the chains 542 and the second sprockets 540b. The second sprockets 540b rotate the drive rods 536, which are attached to the corresponding second sprockets 540b. The motors 532 rotate the first sprockets 540a, the drive chains 542 and the second sprockets 540b in the same direction, which may be a clockwise direction or a counter clockwise direction.

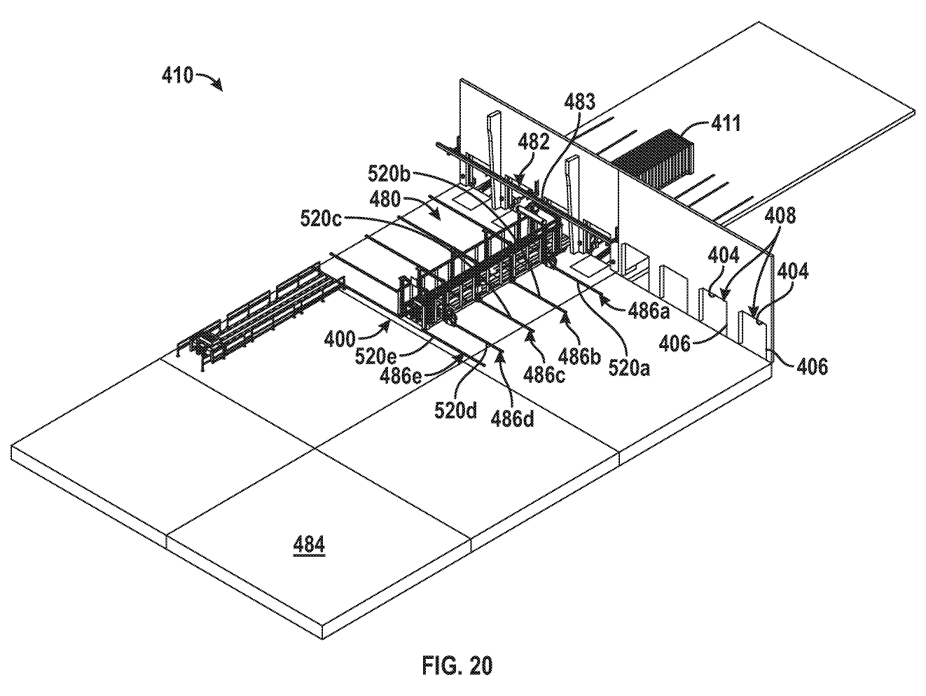

A chain assembly 543 includes a first gear 544a having first teeth that is attached to a first gear rod 545a having opposing ends that are attached to brackets 546 secured to the first housing part 531a by fasteners. Similarly, the chain assembly 543 includes a second gear 544b having second teeth that is attached to a second gear rod 545b having opposing ends that are attached to brackets 546 secured to the first housing part 531a by fasteners. A chain 547 is seated in a channel, such as channels 520a and 520d respectively formed in tracks 486a and 486d, and extends about a portion of the first gear 544a while being engaged by the first teeth. The chain 547 further engages teeth extending outwardly from the drive rod 536 and engages the second teeth on a portion of the second gear 544b as shown in FIG. 26B. The first gear 544a and the second gear 544b simultaneously rotate in a clockwise direction or in a counter clockwise direction based on the rotational direction of the drive rod 536. The rotation of the drive rod 536 causes the chain 547 to move in a corresponding direction and the first gear 545a and the second gear 545b to successively engage openings in the chain 547 to move the transport apparatus 480 in a first lateral direction or an opposing, second lateral direction along the tracks 486a to 486e shown in FIG. 20.

A cage member 550 extends along and is connected to the upper ends of the u-shaped support members 496 and supports electrical cables connected to a first control unit (not shown) coupled to the first drive assembly 526, a main control box 552 having a housing 554 and a door 556 and a second control unit (not shown) coupled to the second drive assembly 528. In this way, the electrical power provided to the first drive assembly 526 and the second drive assembly 528 is controlled by the main control box, where the electrical power to the first drive assembly 526 and the second drive assembly 528 may be turned on or turned off by engaging buttons connected to the housing 554 of the main control box. The cage member 550 also extends along the vertical supports at the ends of the frame 488. Specifically, electrical cables or wires extend along the vertical supports at the end the frame 488 and are coupled to opposing hydraulic units 558. The hydraulic units 558 are connected to opposing sides of a ramp 560 that is pivotably attached to the frame 488, where the hydraulic units 558 cause the ramp 560 to pivot between a lower position shown in FIG. 26 and an upper position where the upper surface of the ramp 560 is adjacent to or in contact with the rollers 504 at the end of the frame 488. Also, an air accumulation tank 548 is attached to a top end of the transport apparatus 480 and accumulates compressed air from the different air cylinders.

The opposing second side 524 of the frame 488 includes a plurality of the roller assemblies 510 where each of the roller assemblies are attached to a corresponding one of the u-shaped support members 496. In operation, the rollers 516 associated with the roller assemblies 510 engage and roll along corresponding channels 520a, 520b, 520c and 520d in the tracks 486a, 486b, 486c and 486d in the facility floor 484 when the transport apparatus 580 is moving along the facility floor 484.

The end of the frame 488 includes locking pin assemblies 562 that each have a housing 564, a motor 566 and a pin 568 coupled to the motor, where the motor causes the pin 568 to move between a locking position and a unlocking position. The cage member 550 extends to the locking pin assemblies 562 and encloses electrical cables coupled to the motors that control the operation of the motors. In operation, the motors 566 cause the pins 568 to each move to the locking position in engagement with the frame of the loading and unloading apparatus 50 described above to lock the loading and unloading apparatus in place in the transport apparatus 580. The loading and unloading apparatus 50 is released from the transport apparatus 580 by moving the pins 568 to the unlocking position.

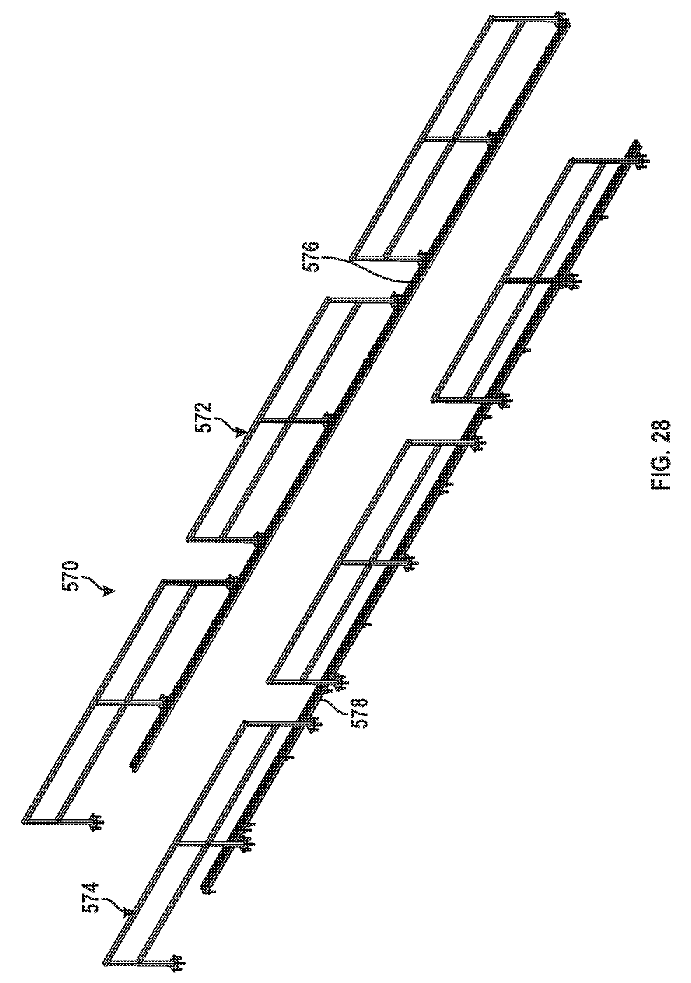

Referring to FIGS. 19, 20, 27 and 28, a storage area 570 for storing the container loading and unloading apparatus 50 described above, when not in use, is designated on the floor 484 of the facility 410. As shown, the storage area 570 is located at an end of the tracks 486a, 486b, 486c, 486d and 486e. The storage area 570 may also be at the opposing end of the tracks 486a, 486b, 486c, 486d and 486e or at location between the ends of the tracks. A first railing 572 and a second railing 574 are secured to the facility floor 484 and are spaced a designated distance from each other. Specifically, the distance between inner surfaces of the first railing 572 and the second railing 574 is greater than a width of container loading and unloading apparatus 50. The storage area 570 also includes first and second side tracks 576 and 578 that are secured to the facility floor 484 and placed along the bottom ends of the first and second railings 572 and 574. The first and second railings 572 and 574 and the first and second side tracks 576 and 578 help to align the loading and unloading apparatus 50 as it moves over the lateral tracks and into position to be transported laterally on the floor 484. As shown, the first railing 572 and the second railing 574 each include three sections that are spaced from each other. It should be appreciated that the first railing 572 and the second railing 574 may each be a continuous railing, or include a plurality of spaced sections.

Referring to FIGS. 19 to 21 and 29 to 31, the operation of the transport system will be described when a transport vehicle, such as a truck having a trailer, arrives at a facility 410, where the trailer has a shipping container 411 carrying a plurality of pallets 56 carrying product 58. In this embodiment, the shipping container 411 on the trailer is a forty foot (40 ft) container. The transport system 400 may also be configured to receive products from 40 ft and 20 ft ISO shipping containers (standard cube and high cube), specialty shipping containers, such as flat rack trailers, open top trailers, flatbed trailers, dry vans or any suitable transport vehicle that transports products between locations, where transport vehicle may be configured to carry trailers or shipping containers having any suitable height and length. In this embodiment, the container 411 is configured to store and transport eighteen (18) pallets 56 that each are carrying products 58. The products 58 may all be the same products or one or more of the pallets 56 may be carrying different products 58.

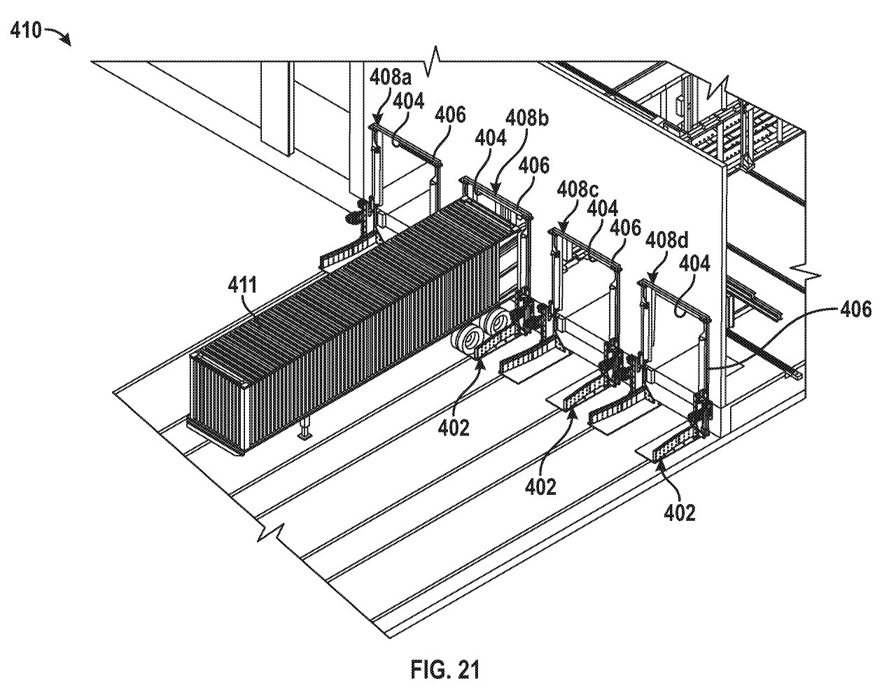

As shown in FIGS. 19 and 21, a transport vehicle including a trailer or shipping container 411 arrives at a facility 410, where the transport vehicle moves in reverse to align the door opening at the rear end of the shipping container 411 with one of the door openings 404 at a docking station 408 at the facility 411. The transport vehicle moves the trailer/shipping container 411 so that the rearmost set of wheels on the trailer initially engage inner surfaces of the angled portions 436 of the guide walls 434 on the container alignment apparatus 402 at the docking station 408. The angled portions 436 of the guide walls 434 guide the rearmost wheels of the trailer inwardly to the inner surfaces of the straight portions 438 of the guide walls 434, where the straight portions of the guide walls 434 are spaced apart at a distance that is approximately equal to a width of the door opening 404 adjacent to the container alignment apparatus 402. In this way, the rear access opening of the trailer is substantially, laterally aligned with the door opening 404 at the docking station 408.

After the rear access opening of the trailer is positioned adjacent to the door opening 404 at the docking station 408, compressed air is delivered to the air cylinders 549 to move the pins 472 of the pin assemblies 468 inwardly into engagement with corresponding openings or open areas on opposing sides of the trailer, to secure the trailer in position relative to the door opening 404. Once secured in position, a user determines whether the upper surface of the floor inside the trailer is substantially flush with the upper surface of the floor 484 inside the facility 410. If the upper surfaces of the floor inside the trailer and the floor 484 in the facility 410 are not substantially flush, the user uses the controller to activate the motors 466, which in turn, causes the bars on the moving devices 474 to pivot upwardly and correspondingly move the posts 464 upwardly. The upward movement of the posts 464 causes the trailer to move upwardly until the upper surface of the floor inside the trailer is substantially flush with the upper surface of the floor 484 inside the facility 410. The trailer is held in this position until the trailer is ready to leave the facility 410. At that time, the motors 466 are activated and cause the moving devices 474 to pivot downwardly, which causes the posts 464 and the trailer to move downwardly. The controller then communicates with the pin assemblies 468 to move the pins 472 away from and out of engagement with the trailer.

In another embodiment, one or more sensors (not shown) are placed at or near the door opening 404 to sense the upper surface of the floor inside the trailer and determine whether the upper surface of the floor inside the trailer is substantially flush with the upper surface of the floor 484 inside the facility 410. The one or more sensors are in communication with the controller having a processor and a memory, where one or more programs are stored in the memory and control the height of the trailer using the sensed position of the floor of the trailer relative to the floor 484. If the sensed position of the floor inside the trailer is not flush with the upper surface of the floor 484 inside the facility 410, the controller utilizes the one or more programs to automatically adjust the position (height) of the trailer relative to the floor 484 so that the upper surface of the floor inside the trailer is substantially flush with the upper surface of the floor 484 inside the facility 410.

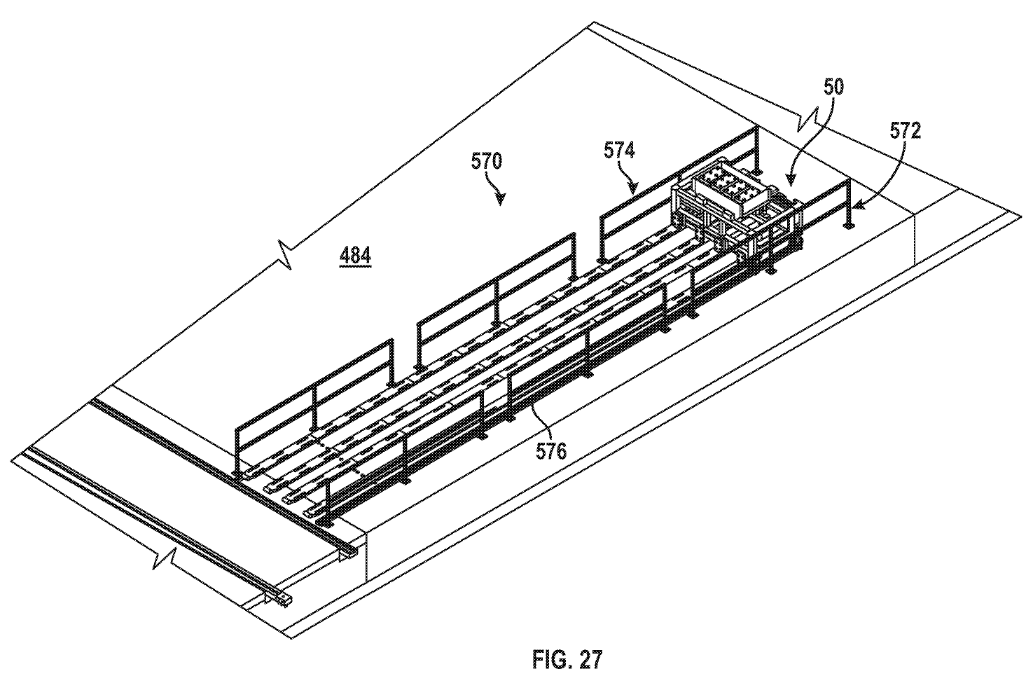

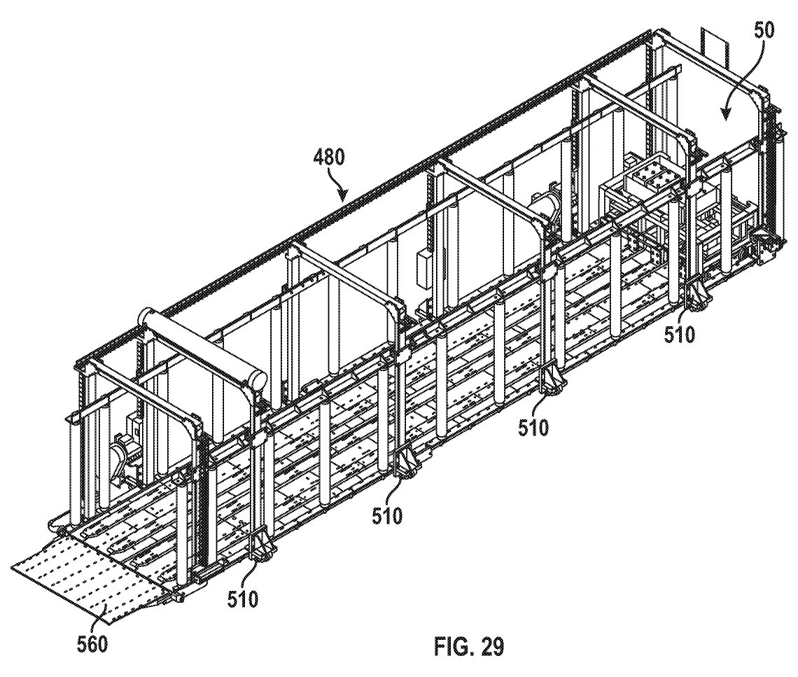

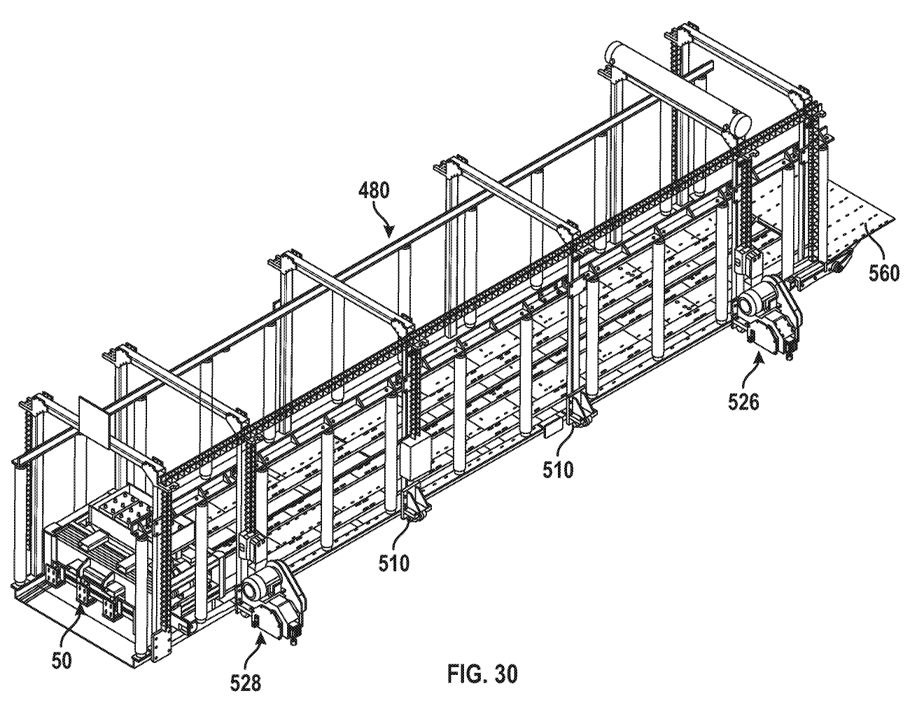

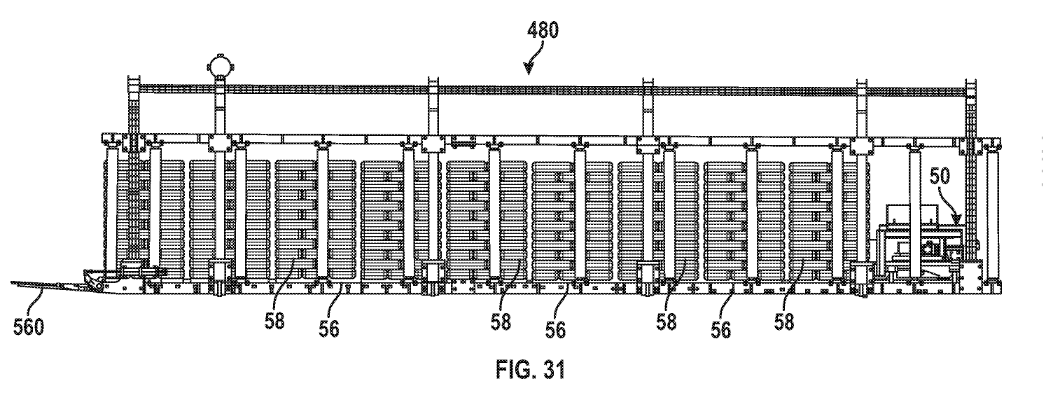

When the trailer is secured in position and the floor of the trailer is substantially aligned with the floor 484 of the facility 410, the transport apparatus 480 is moved along the tracks by the first and second drive assemblies 526 and 528 as described above until the transport apparatus 480 is aligned with the storage area 570 containing the loading and unloading apparatus 50 (FIG. 27). The loading and unloading apparatus 50 moves out of the storage area 570 while being guided by the first and second side tracks 576 and 578 and into the transport apparatus 480 as shown in FIGS. 29 and 30. As the loading and unloading apparatus 50 moves into the transport apparatus 480, the outer surfaces of the loading and unloading apparatus 50 engages the surfaces of the rollers 504 of the transport apparatus 480, where the rollers 505 rotate and guide the loading and unloading apparatus 50 into the transport apparatus 480. When the loading and unloading apparatus 50 is moved fully into the transport apparatus 480, the motors on the transport apparatus 480 are activated and move each of the pins 568 inwardly from a first position or unlocked position, to a second position or locked position, where the pins 568 are in engagement with the loading and unloading apparatus 50 to secure the loading and unloading apparatus 50 to the transport apparatus 480.

The transport apparatus 480 is now moved into alignment with the door opening 404 that is adjacent to the trailer having the shipping container 411, by activating the first and second drive assemblies 526 and 528 to move the transport apparatus 480 laterally along the tracks 486a to 486e in the floor 484 of the facility 410. When the transport apparatus 480 is aligned with the door opening 404, the ramp 560 at the end of the transport apparatus 480 is moved or pivoted downwardly until the ramp 560 engages the floor inside the trailer or until the end of the ramp 460 is adjacent to the floor inside the trailer. The pins 472 on the transport apparatus 480 are moved outwardly away from and out of engagement with the loading and unloading apparatus 50. The loading and unloading apparatus 50 now moves into the shipping container 411 so that the forks of the loading and unloading apparatus 50 move into corresponding openings at the bottom of the pallets 56 inside the container on the trailer. When the forks of the loading and unloading apparatus 50 are fully moved under all of the pallets 56 inside the container 411, the forks are raised as described above, to correspondingly simultaneously raise or lift all of the pallets 56. The loading and unloading apparatus 50 now moves outwardly from the container 411 on the trailer and back into the transport apparatus 480. When the loading and unloading apparatus 50 is moved into the transport apparatus 480, the pins 472 are moved inwardly into engagement with the loading and unloading apparatus 50 to secure the loading and unloading apparatus 50 to the transport apparatus 480. Additionally as shown in FIG. 31, the ramp 560 is moved or pivoted upwardly until the ramp contacts or is adjacent to the frame 488 of the transport apparatus 480.

The transport apparatus 480 laterally moves the loading and unloading apparatus 50 and the products 58 on the pallets 56 to a designated position on the tracks in the facility 410. The pins 472 are then moved outwardly from and out of engagement with the loading and unloading apparatus 50 to release the loading and unloading apparatus. The loading and unloading apparatus 50 now moves outwardly from the end of the transport apparatus 480, where the rollers 504 help to guide the pallets 56 and products 58 on the pallets and the loading and unloading apparatus 50 out of the transport apparatus 480. The loading and unloading apparatus 50 simultaneously transports the pallets 56 with the products 58 to a designated area inside the facility 410, such as a storage area or a manufacturing area. The forks of the loading and unloading apparatus 50 are lowered so the pallets 56 contact the floor 484 of the facility 410, and then the loading and unloading apparatus 50 moves outwardly away from the pallets 56 until the forks are completely out of the openings in the pallets 56. The loading and unloading apparatus 50 then moves to another area in the facility 410 to transport other pallets 56 or moves back into the transport apparatus 480 to be moved to another door opening 404 or back to the storage area 570.

The process is repeated when a plurality of pallets 56 are to be shipped to another location. Specifically, the forks of the loading and unloading apparatus 50 are moved under the pallets 56 with the products 58 and all of the pallets are simultaneously raised as described above. The loading and unloading apparatus 50 then moves into the transport apparatus 480 and is secured in place as described above. The transport apparatus 480 laterally moves the loading and unloading apparatus 50 carrying the pallets 56 with products 58 to a door opening 404. The ramp 560 is lowered and the loading and unloading apparatus 50 is released from the transport apparatus 480. The loading and unloading apparatus 50 then moves the pallets 56 with the products 58 into a shipping container 411 on a trailer of a transport vehicle, where the forks are lowered until the pallets 56 contact the floor inside the container. The loading and unloading apparatus 50 then moves back into the transport apparatus 480, where the ramp 560 is raised and the loading and unloading apparatus 50 is secured to the transport apparatus 480. The transport apparatus 480 moves laterally along the facility floor 484 to move the loading and unloading apparatus 50 to another area in the facility 410 or to the storage area 570.

While particular embodiments of the present loading and unloading apparatus and transport system is shown and described, it will be appreciated by those skilled in the art that changes and modifications may be made thereto without departing from the invention in its broader aspects and as set forth in the following claims.

What is claimed is:

1. A transport system for a loading and unloading apparatus used at a facility, the transport system comprising:
a transport apparatus configured to receive the loading and unloading apparatus, said transport apparatus including a frame having a bottom wall and opposing sidewalls extending from said bottom wall, and at least one drive assembly attached to said frame; and
a plurality of tracks in a floor of the facility, said at least one drive assembly positioned in one of said plurality of tracks,
wherein said drive assembly moves said transport apparatus along said plurality of tracks to different positions on the floor of the facility.

2. The transport system of claim 1, wherein said transport apparatus includes two drive assemblies, said two drive assemblies being spaced apart and attached to said frame.

3. The transport system of claim 2, further comprising a main control box attached to said frame, said main control box including a control unit electrically coupled to and in communication with said two drive assemblies

4. The transport system of claim 1, wherein one of said tracks includes a channel and a chain secured in said channel, said at least one drive assembly being configured to successively engage links in said chain to move the transport apparatus along said plurality of tracks.

5. The transport system of claim 4, further comprising roller assemblies attached to said frame, said roller assemblies each including a roller, wherein said rollers of said roller assemblies are configured to engage and roll along a corresponding track of said plurality of tracks.

6. The transport system of claim 1, further comprising a ramp pivotably attached to an end of said frame of said transport apparatus, wherein said ramp moves between an upper position and a lower position.

7. The transport system of claim 1, further comprising a pair of pins movably attached to opposing sides of said frame at an end of said frame, said pins being movable between an unlocked position to a locked position in engagement with the loading and unloading apparatus to secure the loading and unloading apparatus to the transport apparatus.

8. The transport system of claim 1, wherein said opposing sidewalls each include a plurality of rollers that are configured to rotate relative to said frame.

9. The transport system of claim 8, wherein two of said plurality of rollers are rotatably attached to a first end of said frame and another two of said plurality of rollers are rotatably attached to an opposing, second end of said frame.

10. The transport system of claim 1, further comprising a main control box attached to said frame, said main control box including a control unit electrically coupled to and in communication with said at least one drive assembly.

11. A transport system for a loading and unloading apparatus used at a facility, the transport system comprising:
a container alignment apparatus secured adjacent to a door opening at the facility, said container alignment apparatus including opposing guide walls configured to guide wheels of a trailer so that a door opening of said trailer is aligned with the door opening at the facility;
a transport apparatus configured to receive the loading and unloading apparatus, said transport apparatus including a frame having a bottom wall and opposing sidewalls extending from said bottom wall, and at least one drive assembly attached to said frame; and
a plurality of tracks in a floor of the facility, said at least one drive assembly positioned in one of said plurality of tracks,
wherein said drive assembly moves said transport apparatus along said plurality of tracks to align said transport apparatus with said door opening at the facility.

12. The transport system of claim 11, wherein said opposing guide walls of said container alignment apparatus each includes an angled portion and a straight portion.

13. The transport system of claim 11, wherein said container alignment apparatus includes a frame and opposing pins movably attached to said frame, said opposing pins each being movable between an unlocked position and a locked position, wherein in said locked position, said pins are engaged with the trailer.

14. The transport system of claim 13, wherein said container alignment apparatus includes opposing posts attached to said frame, said posts being movable upwardly and downwardly relative to said frame to move the trailer relative to the door opening at the facility.

15. The transport system of claim 11, wherein said transport apparatus includes two drive assemblies, said two drive assemblies being spaced apart and attached to said frame of said transport apparatus.

16. The transport system of claim 15, further comprising a main control box attached to said frame of said transport apparatus, said main control box including a control unit electrically coupled to and in communication with said two drive assemblies

17. The transport system of claim 11, wherein one of said tracks includes a channel and a chain secured in said channel, said at least one drive assembly being configured to successively engage links in said chain to move the transport apparatus along said plurality of tracks.

18. The transport system of claim 17, further comprising roller assemblies attached to said frame, said roller assemblies each including a roller, wherein said rollers of said roller assemblies are configured to engage and roll along a corresponding track of said plurality of tracks.

19. The transport system of claim 11, further comprising a ramp pivotably attached to an end of said frame of said transport apparatus, wherein said ramp moves between an upper position and a lower position.
